(19) United States
(12) Patent Application Publication
(10) Pub. No.: US 2009/0251668 A1
(43) Pub. Date: Oct. 8, 2009

(54) Scanning image projector

(76) Inventor: Koichi Takahashi, Shibuya-ku (JP)

Correspondence Address: KENYON & KENYON LLP, ONE BROADWAY, NEW YORK, NY, 10004, US

(21) Appl. No.: 12/384,436

(22) Filed: Apr. 2, 2009

(30) Foreign Application Priority Data
Apr. 7, 2008 (JP) 2008-099239

(51) Int. Cl. G03B 21/28

(52) U.S. Cl. 353/33

(57) ABSTRACT

The invention relates to a scanning image projector that facilitates making the whole optical system compact while making it easy to control an image being projected. The scanning image projector comprises a light source unit that gives out a light beam modulated on the basis of image information, a deflector that reflects the light beam for deflecting and scanning it in a two-dimensional direction, and a projecting optical system that projects a light beam reflected by the deflector toward a projection direction to form a two-dimensional image. The projecting optical system 6 comprises a plurality of reflecting surfaces 12, 13 tilted with respect to a chief ray of a light beam leading to the center of the projected image. At least one of the plurality of reflecting surfaces 13, 14 is a curved reflecting surface of concave shape at a position where the chief ray 21 of a light beam leading to the center of the projected image goes by. A chief ray of a light beam leading to an end of the image leaves in a direction away form the chief ray 21 of the light beam leading to the center of the projected image as it is out of the projecting optical system 6.

### BACKGROUND OF THE INVENTION

The present invention relates generally to a scanning image projector, and more particularly to a scanning image projector capable of displaying images by the two-dimensional scanning of light beams.

Among light beam scanning image projectors known so far in the art, there is a scanning image projector wherein light beams of three colors: R (red), G (green) and B (blue) modulated according to image signals are reflected and deflected by a deflector for two-dimensional scanning thereby projecting an image, as disclosed typically in Patent Publications 1 and 2.

Patent Publication 1 discloses a scanning image projector wherein a polygon mirror or galvanomirror is used as the deflector for two-dimensional scanning of light beams thereby projecting images onto a screen.

Patent Publication 2 discloses a scanning image projector wherein a mode using such a deflector as set forth in Patent Publication 1 is combined with a galvanomirror with a biaxial movable mirror or an orthogonal uniaxial galvanomirror for two-dimensional scanning of light beams thereby projecting images onto a screen.

Patent Publication 1

JP(A) 2003-84707

Patent Publication 2

JP(A) 2006-186243

With the conventional arrangement wherein light beams of RGB three colors modulated by image signals are reflected and deflected by the deflector for on-screen two-dimensional scanning, however, light beams are scanned depending on the angle of deflection of the deflector, yet without any optical device between the deflector and the screen. In other words, once the light beams have been deflected by the deflector, their control is only implemented by an optical system before their incidence onto the deflector.

For this reason, there is none of on-screen correction of distortion, control of the diameter of the light beams leaving the deflector or the like: the projected image cannot be corrected for its total configuration, and fails to provide high-definition displays, or the like.

### SUMMARY OF THE INVENTION

With such problems with the prior art in mind, an object of the invention is to provide a scanning image projector that facilitates making the whole optical system compact while making it easy to control images being projected.

According to the present invention, the above object is accomplishable by the provision of a scanning image projector, characterized by comprising:

a light source unit that gives out a light beam modulated on the basis of image information,

a deflector that reflects said light beam for deflecting and scanning it in a two-dimensional direction, and

a projecting optical system that projects a light beam reflected by said deflector toward a projection direction to form a two-dimensional image, wherein:

said projecting optical system comprises a plurality of reflecting surfaces tilted with respect to a chief ray of a light beam leading to the center of said projected image,

at least one of said plurality of reflecting surfaces is a curved reflecting surface of concave shape at a position where the chief ray of a light beam leading to the center of said projected image goes by, and

a chief ray of a light beam leading to an end of said image leaves in a direction away form the chief ray of the light beam leading to the center of said projected image as it is out of said projecting optical system.

With such arrangement, the light beam given out of the light source is deflected and scanned by the deflector, entering the projecting optical system.

The location of the projecting optical system enables scanning magnification and the diameter of a light beam to be determined in association with the angle of deflection, so that distortion of the periphery of the projected image is minimized and the contrast of the whole screen is enhanced.

The location of the plurality of reflecting surfaces tilted with respect to the chief ray of the light beam leading to the center of the projected image works in favor of making sure an optical path is taken through the projecting optical system and size reductions.

According to the invention, at least one of plural reflecting surfaces is configured into concave shape at the position where the chief ray of the light beam leading to the center of the projected image goes by, so that it can be given positive optical power to enable optical design favorable for size reductions.

According to the invention, the chief ray of the light beam leading to the end of the projected image is allowed to leave in a direction away from the chief ray of the light beam leading to the center of the projected image as it is out of the projecting optical system, so that the size of the projected image can easily be large with respect to the projecting optical system.

The “axial chief ray” referred to hereinafter means the chief ray of the light beam leading to the center of the projected image: it is defined as a light ray passing through both the center of the image projected by the projecting optical system and the center of the entrance pupil of the projecting optical system.

For the aforesaid invention it is more desirable to satisfy any one of the following requirements.

That is, it is desired that the aforesaid curved reflecting surface in the projecting optical system be of an irrotational symmetric, aspheric shape.

This arrangement works more in favor of diminishing aberrations due to decentration than a reflecting surface of rotational symmetric shape, and so in favor of diminishing distortion of the projected image and contrast improvements.

When the aforesaid curved reflecting surface is used as the first curved reflecting surface, the projecting optical system may have that first curved reflecting surface plus the second curved reflecting surface.

If at least two reflecting surfaces are in the form of curved reflecting surfaces as mentioned just above, it is then easy to correct aberrations resulting from decentration, favoring size reductions of the projecting optical system.

In that case, it is desired that the first and the second curved reflecting surface be each of an irrotational symmetric, aspheric shape.

Thus, the use of two such aspheric surfaces of irrotational symmetric shape gives the designer greater freedom, and works more in favor of correcting aberrations resulting from decentration, diminishing image distortion, improving contrast, and achieving size reductions.

It is also desired that the projecting optical system comprise a prism having the first and second curved reflecting surfaces defined by internal reflecting surfaces.

Such arrangement helps minimize relative displacements of plural curved reflecting surfaces, reducing production errors. Especially when they are produced by injection molding or the like, the production errors are minimized in terms of the shape of each prism surface, and relative surface locations. In other words, for adjustment of the positions of the deflector that is an entrance pupil position and the projecting optical system it is only needed to fix the prism at the desired position, dispensing with any adjustment process.

It is also possible to utilize the refraction of the refracting surface on the entrance side thereby making small the angle between the light beam leading to the image ends and the axial chief ray. On the other hand, it is possible to utilize the refraction of the refracting surface on the exit side thereby making large the angle between the light beam directing toward the image ends and the axial chief ray, working in favor of offering a sensible tradeoff between the size reductions of the projecting optical system and making sure the angle of projection.

In this case, the prism in the projecting optical system includes three optical surfaces: a first surface having transmission, a second surface having internal reflection plus transmission and a third surface having reflection. An optical path here from the first surface to the third surface is filled with a medium having a refractive index greater than 1.3, and an incoming light beam from the deflector takes an optical path of reflection: it enters the prism through the first surface, and undergoes reflection at the second surface and then at the third surface, transmitting through the second surface and out of the prism.

Thus, both functions: reflection and transmission are given to the second reflecting surface so that prism size can be reduced while making sure the optical path through the prism, working in favor of size reductions. This arrangement corresponds to Example 1, given later.

Alternatively, the prism in the projecting optical system may include four optical surfaces: a first surface having transmission, a second surface having internal reflection, a third surface having internal reflection and fourth transmitting surface. An optical path from the first to the fourth surface is filled with a medium having a refractive index greater than 1.3, and an incoming light beam from the deflector takes an optical path of reflection: it enters the medium through the first surface, and undergoes reflection at the second surface and then at the third surface, transmitting through the fourth surface and out of the prism.

Thus, it is possible to utilize the refraction of the first, and the fourth surface thereby favorably offering a sensible tradeoff between prism size reductions and making sure the desired angle of projection. It is also possible to utilize curved reflection at the second, and the third surface thereby facilitating balancing the collection of light beams against correction of image distortion, working in favor of making sure the optical path through the projecting optical system and size reductions. This arrangement corresponds to Example 2, given later.

In this case, it is desired that the second, and the third surface be located at a position where the light beam leading to the center of the projected image is reflected at an acute angle and crosses itself, and that the second, and the third surface be of concave shape at a position where the chief ray of the light beam leading to the center of the projected image goes by.

Such arrangement allows the light beam from the reflecting surface of the deflector that is the entrance pupil to take a symmetrical optical path: an optical path of light that is reflected at the second surface in the prism and an optical path of light that is reflected at the third surface, out of the fourth surface. In addition, because positive power is distributed to the two reflecting surfaces, aberrations occurring from the decentered reflecting surface are easily diminished. This arrangement corresponds to Example 2, given later.

In this case, it is desired that the fourth surface be concave on the exit side.

Such arrangement allows negative power to be given to the fourth surface that is the exit surface, working in favor of holding back field curvature that is an off-axis aberration. This arrangement corresponds to Example 2, given later.

It is desired that both the first curved reflecting surface and the second curved reflecting surface be concave reflecting surfaces, and an intermediate image be formed in an optical path between the first and the second curved reflecting surface.

Such arrangement allows the light beams from the deflector to be once collected in the projecting optical system to form a set of two-dimensional points, i.e., an intermediate (primary) image. Projection of that intermediate image makes projecting magnification control easy. The concave reflecting surface located in an optical path on a deflector side with respect to the intermediate image contributes to collecting the light beams to form the intermediate image, and the concave reflecting surface located on a projection side with respect to the intermediate image contributes to controlling the spreading of light beams from the intermediate image and adjusting light beam diameter and projecting magnification. This arrangement corresponds to Examples 3, 4 and 5, given later.

In this case, it is desired that the first curved reflecting surface be opposite to the second curved reflecting surface with the intermediate image sandwiched between them.

And it is desired that a pupil conjugate to the entrance pupil be formed on the projecting optical system and on a projection side with respect to the intermediate image.

Such arrangement allows the concave surfaces of positive power to be located just before and just after the intermediate image, working in favor of size reductions of the projecting optical system. This arrangement corresponds to Examples 3, 4 and 5, given later.

And it is desired that a pupil conjugate to the entrance pupil be formed in the projecting optical system and on a projection side with respect to the intermediate image.

Thus, if the intermediate image and the pupil are provided in the projecting optical system, it works more in favor of offering a sensible tradeoff between making sure the optical path through the projecting optical system and size reductions. This arrangement corresponds to Examples 3, 4 and 5, given later.

It is desired that the prism in the projecting optical system comprise at least four optical surfaces so that the intermediate image is formed in the prism to enlarge and project that intermediate image.

Such arrangement allows the light beams from the deflector to be once collected in the prism to form a set of two-dimensional points, i.e., an intermediate (primary) image. Projection of that intermediate image makes projecting magnification control easy. This arrangement corresponds to Examples 3, 4 and 5, given later.

The prism in the projecting optical system comprises four optical surfaces: a first surface having transmission plus reflection, a second surface having internal reflection, a third surface having internal reflection and a fourth transmitting surface, and an optical path from the first to the fourth surface is filled with a medium having a refractive index greater than 1.3. A light beam given out of the deflector takes an optical path of reflection: it enters the prism through the first surface, and undergoes reflection at the second surface, then at the first surface and then at the third surface, transmitting through the fourth surface and out of the prism. The aforesaid intermediate image may be formed between the second and the third surface.

Thus, the first surface has two functions: transmission whereby the light beams given out of the reflecting surface of the deflector that becomes the entrance pupil of the projecting optical system are introduced into the prism, and reflection whereby the light beams reflected at the second surface that is the internal reflecting surface are reflected. This works in favor of making sure the optical path and the size reductions of the projecting optical system. And the light beams are projected after reflection at the third surface and transmission through the fourth surface. This arrangement corresponds to Examples 3 and 5, given later.

Because the intermediate image is formed between the second and the third surface, making the projecting optical system compact, and adjusting the projecting magnification is easily achievable.

In that case, it is desired that the pupil be formed in the prism.

Such arrangement works more in favor of prism size reductions, because the optical path can be narrowed down.

The first surface may be coated with a reflection coating that enables the light beam to be reflected toward a position upon which the light beam reflected at the second surface strikes.

More specifically, because the intermediate image or pupil is formed near a site of the first surface at which the light beam is reflected, light is collected at a reflection area of the first surface. For this reason, the reflection area of the first surface becomes a narrow area that is set separately of a transmission area. In other words, even if a reflection coating is applied on this site, its influences on the transmission area can then be reduced.

For the reflection coating, for instance, aluminum may be coated to induce internal reflection.

More preferably in view of making sure the first surface has the transmission area, the first reflecting surface should be positioned in an optical path between the intermediate image and the pupil.

When there are four optical surfaces, the intermediate image may be formed in an optical path from the second surface to the first surface, and the second, and the first surface may have a concave reflecting surface.

With such arrangement, it is easier to offer a sensible tradeoff between prism size reductions and light beam control.

An optical path from the third to the fourth surface may cross both an optical path from the first to the second surface and an optical path from the second to the first surface.

Such arrangement having a repeatedly bent optical path works for offering a sensible tradeoff between making sure an optical path through the prism and prism size reductions.

When there are at least four optical surfaces, the prism in the scanning optical system may comprise five optical surfaces: a first surface having transmission, a second surface having internal reflection, a third surface having internal reflection, a fourth surface having internal reflection and a fifth surface having transmission. An optical path between the first and the fifth surface is filled with a medium having a refractive index greater than 1.3. A light beam given out of the deflector takes an optical path of reflection: it enters the medium through the first surface, and undergoes reflection at the second surface, then at the third surface and then at the fourth surface, transmitting through the fifth surface and out of the prism, and the intermediate image is formed between the second and the fourth surface.

With such arrangement, the first surface behaves as a transmitting surface through which the light beam. leaving the reflecting surface of the deflector that is the entrance pupil of the projecting optical system is introduced into the prism, and a light beam transmitting through the first surface is reflected at the second, the third and the fourth surface and projected through the fifth surface. As the intermediate image is formed between the second and the fourth surface, it facilitates making the projecting optical system compact and implementing projecting magnification control. This arrangement corresponds to Example 4, given later.

In this case, it is desired that the pupil be formed in the prism.

Such arrangement works more in favor of prism size reductions because the optical path involved can be narrowed down.

It is then desired that the pupil be formed in an optical path between the intermediate image and the fourth surface.

Such arrangement works more in favor of prism sizer reductions.

When there are five optical surfaces involved, it is desired that the intermediate image be formed in an optical path from the second to the third surface, and the second, and the third surface have a concave reflecting surface.

With such arrangement it is easier to offer a sensible tradeoff between prism size reductions and light beam control.

In that case, it is desired that the fourth surface have a reflecting surface of convex shape.

With such arrangement wherein the second, and the third surface has positive power, the fourth reflecting surface is given negative power, contributing to decreasing the Petzval sum of the whole optical system. This negative power also helps increase the angle of exit of off-axis light rays from the prism, working for making the projection angle of view wide.

An optical path from the fourth to the fifth surface may cross both an optical path from the first to the second surface and an optical path from the second to the third surface.

Such arrangement having a repeatedly bent optical path works for offering a sensible tradeoff between making sure the optical path through the prism and prism size reductions.

In the invention as described above, the deflector may comprise a mirror with mutually orthogonal two axes as axes of rotation.

With such arrangement, the entrance pupil of the projecting optical system can remain substantially at the same position regardless of scanning directions, so that the entrance pupil can be brought near to the projecting optical system, working in favor of offering a sensible tradeoff between making sure the projection angle of view and reducing the size of the projecting optical system.

It is desired that between the light source unit and the deflector there be a converting optical system provided to convert the light beam from the light source unit into a light beam of given diameter and given shape.

With such arrangement, the light beam diameter is controlled by the converting optical system to facilitate enhancing the contrast of the projected image.

It is also desired that the light source unit be a laser light source.

The use of the laser light source as the light source unit works in favor of making sure the brightness of the projected image.

As can be seen from the foregoing explanation, the present invention can provide a scanning image projector that helps make the whole optical system compact while making it easy to control the projected image (for instance, correction of distortion of the projected image, and on-screen control of light beam diameter).

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is illustrative in schematic of the basic arrangement of each example of the inventive scanning image projector.

FIG. 2 is illustrative in the Y-Z section including an axial chief ray of the projecting optical system in Example 1.

FIG. 3 is an enlarged view of a decentered prism forming part of the projecting optical system of FIG. 2.

FIG. 4 is a transverse aberration diagram for the projecting optical system in Example 1.

FIG. 5 is a transverse aberration diagram for the projecting optical system in Example 1.

FIG. 6 is a transverse aberration diagram for the projecting optical system in Example 1.

FIG. 7 is illustrative in the Y-Z section including an axial chief ray of the projecting optical system in Example 2.

FIG. 8 is an enlarged view of a decentered prism forming part of the projecting optical system of FIG. 7.

FIG. 9 is a transverse aberration diagram for the projecting optical system in Example 2.

FIG. 10 is a transverse aberration diagram for the projecting optical system in Example 2.

FIG. 11 is a transverse aberration diagram for the projecting optical system in Example 2.

FIG. 12 is illustrative in the Y-Z section including an axial chief ray of the projecting optical system in Example 3.

FIG. 13 is an enlarged view of a decentered prism forming part of the projecting optical system of FIG. 12.

FIG. 14 is a transverse aberration diagram for the projecting optical system in Example 3.

FIG. 15 is a transverse aberration diagram for the projecting optical system in Example 3.

FIG. 16 is a transverse aberration diagram for the projecting optical system in Example 3.

FIG. 17 is illustrative in the Y-Z section including an axial chief ray of the projecting optical system in Example 4.

FIG. 18 is an enlarged view of a decentered prism forming part of the projecting optical system of FIG. 17.

FIG. 19 is a transverse aberration diagram for the projecting optical system in Example 4.

FIG. 20 is a transverse aberration diagram for the projecting optical system in Example 4.

FIG. 21 is a transverse aberration diagram for the projecting optical system in Example 4.

FIG. 22 is illustrative in the Y-Z section including an axial chief ray of the projecting optical system in Example 5.

FIG. 23 is an enlarged view of a decentered prism forming part of the projecting optical system of FIG. 22.

FIG. 24 is a transverse aberration diagram for the projecting optical system in Example 5.

FIG. 25 is a transverse aberration diagram for the projecting optical system in Example 5.

FIG. 26 is a transverse aberration diagram for the projecting optical system in Example 5.

### DESCRIPTION OF THE PREFERRED EMBODIMENTS

The scanning image projector of the invention is now explained with reference to some examples.

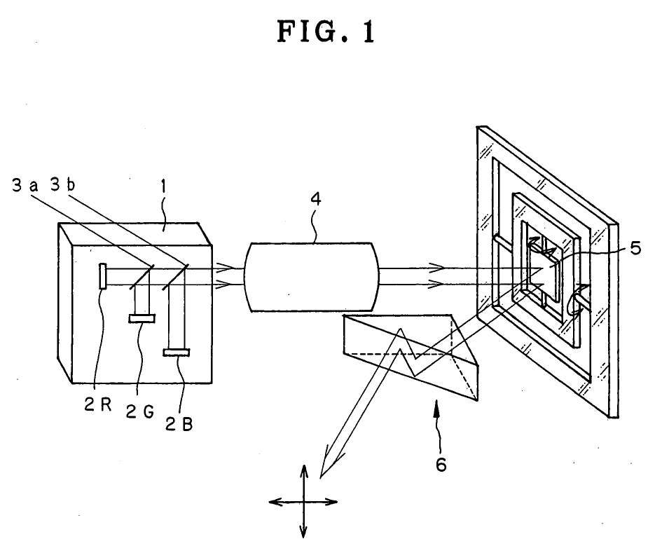

First, the basic arrangement of each example is shown in FIG. 1. A laser light source unit 1 is used as the light source. The laser light source unit 1 comprises laser light sources 2R, 2G and 2B giving out the three primaries R (red), G (green) and B (blue). The laser light sources 2R, 2G and 2B each give out a light beam modulated on the basis of associated image information. The light beams given out of the light sources 2R, 2G and 2B are combined together by two dichroic mirrors 3a and 3b, leaving the laser light unit 1.

The light beams given out of the laser light source unit 1 are converted by a converting optical system 4 into a light beam of given diameter and given shape, leaving the converting optical system 4 in the form of substantially parallel light beams. The converting optical system 4 comprises a collimator lens (not shown) for adjusting the spreading of light beams from the laser light source unit 1 and an optical system (not shown) for shaping the light beams in order.

Upon leaving the converting optical system 4, the substantially parallel light beams are reflected off by a gimbal type biaxial galvanomirror 5 that rotates about two axes that are mutually orthogonal in the vertical and horizontal directions. The direction of light reflected off the biaxial galvanomirror 5 has correlations with the hue and brightness of the light beams given out of the laser light source unit 1, and as the light beams are two-dimensionally scanned by the biaxial galvanomirror 5, they are controlled such that there is a two-dimensional image formed on a projection side.

The light beams reflected off by the biaxial galvanomirror 5 enter a projecting optical system 6.

Entering the projecting optical system 6, the light beams are reflected at a plurality of reflecting surfaces in the projecting optical system 6 so that their direction of projection is controlled. The reflecting surfaces in the projecting optical system 6 are each constructed of a curved surface, and have functions of shaping the light beams in order and correcting the projected image for distortion. Note here that FIG. 1 is a schematic view and the reflecting surfaces in the projecting optical system 6 are drawn there in planar form; however, they are constructed of curved surfaces such as free-form surfaces, as will be seen from the examples, given later.

In the embodiment here, the biaxial galvanomirror 5 is used as the deflector; however, use may be made of a plurality of uniaxial galvanomirrors or a polygon mirror.

In FIG. 1, the laser source unit 1, the converting optical system 4, and the modulation mode used is shown in a simplified fashion; however, known arrangements and known modulation modes may be used.

Exemplary arrangements of the projecting optical system set up as mentioned above are now explained. Note here that each of the following projecting optical systems is constructed of a single prism, but of course variations such as addition of auxiliary lenses may be implemented as desired.

Each projecting optical system here is constructed such that the entrance pupil takes the sample position in both the vertical and the horizontal direction to work in favor of prism size reductions and making sure the projection angle of view; however, it may take different positions in the vertical and the horizontal directions.

In addition, each projecting optical system may be constructed in such a way as to rotate and move with the axial chief ray passing through the entrance pupil as an axis of rotational symmetry.

In each example, the center of the entrance pupil is defined by the point of intersection of the axes of rotational symmetry of the biaxial galvanomirror 5 (FIG. 1), and the center of light beams incident onto the biaxial galvanomirror 5 and the reflecting surfaces are placed over that point of intersection.

In each example, the Y-Z plane lies in the vertical direction of the projected image; however, the prism may be located such that the Y-Z plane lies in the horizontal direction of the projected image.

The projecting optical system 5 used with the scanning image projector of the invention is now explained with reference to Examples 1 to 5. The key parameters in each example will be described later.

Reference is first made of the coordinate system, decentered surface and free-form surface used in the following examples.

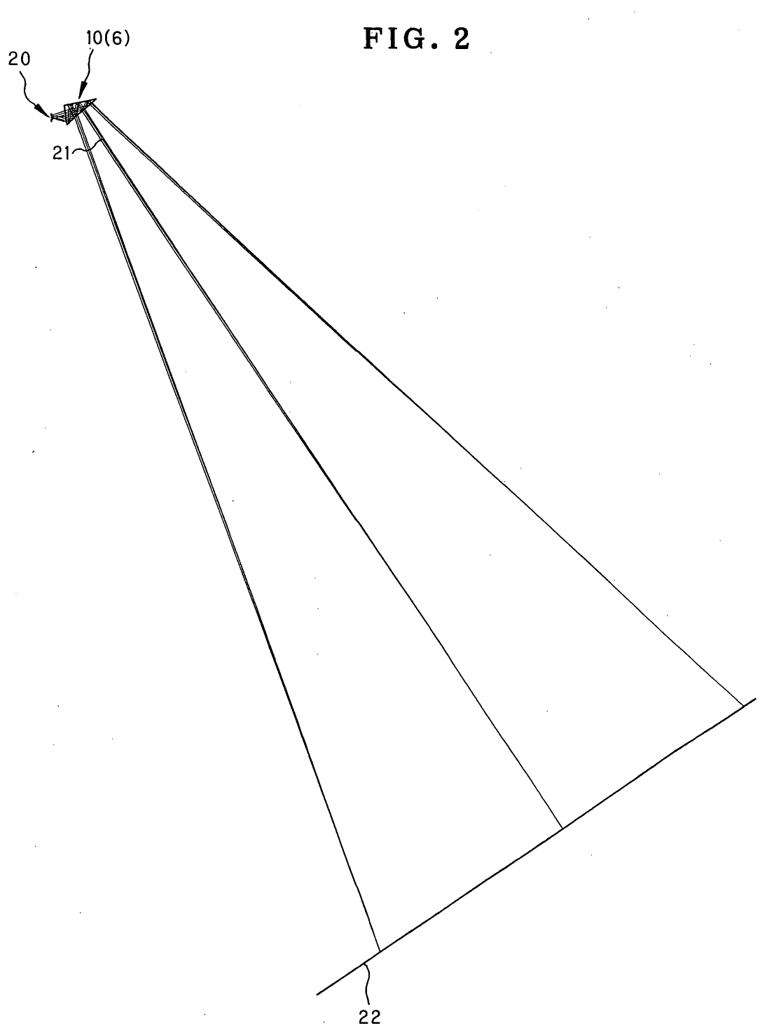

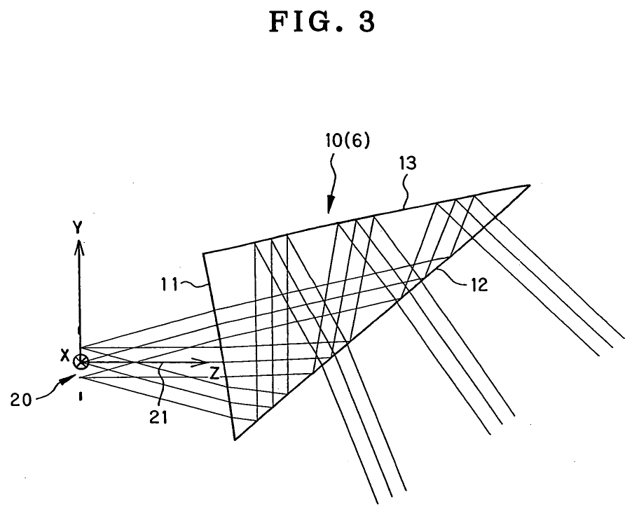

In each example, an axial chief ray 21 is defined by a light ray passing through the center of an entrance pupil 20 (corresponding to an aperture in the biaxial galvanomirror 5 of FIG. 1) and arriving at the center of a projection plane 22 (FIG. 2), as shown in FIG. 3.

And let the center of the entrance pupil 20 be the origin, let the direction of light traveling along the axial chief ray 21 be the positive Z-axis direction, let a plane containing that Z-axis and the center of the image plane be the Y-Z plane, let the positive X-axis direction be defined by a direction through the origin, orthogonal to the Y-Z plane and to the backside of the paper, and let the Y-axis be defined by an axis that forms a right-handed orthogonal coordinate system with the X- and Z-axes.

In Examples 1 to 5, each surface is decentered within that Y-Z plane, and only one plane of symmetry of each rotationally asymmetric free-form surface is given by the Y-Z plane.

Given for the decentered surface are the amount of decentration of the apex of that surface from the center of the origin of the thus determined coordinate system (X, Y and Z in the X-, Y- and Z-axis directions) and the angles (α, β, γ) of tilt of the center axis (the Z-axis in the following formula (a) for a free-form surface and the Z-axis in the following formula (b) for an aspheric surface) with respect to the X-axis, the Y-axis, and the Z-axis, respectively. It is here noted that the positive α and β mean counterclockwise rotation with respect to the positive directions of the respective axes, and the positive γ means clockwise rotation with respect to the positive direction of the Z-axis. Referring to for the α, β, and γ rotation of the center axis of a certain surface, the center axis of that surface and the associated XYZ orthogonal coordinate system are first a rotated counter-clockwise about the X-axis. Then, the center of the rotated surface is β rotated counterclockwise about the Y-axis of a new coordinate system, and the once rotated coordinate system is β rotated counterclockwise about the Y-axis too. Then, the center axis of the twice rotated surface is g rotated clockwise about the Z-axis of a new coordinate system.

Regarding the optical function surfaces forming the optical system of each example, when a specific surface and the subsequent surface form a coaxial optical system (including a planar reflection prism), a spacing is given. Besides, the refractive indices and Abbe constants of media are given as usual.

The free-form surface used herein is defined by the following formula (a), and so the axis of the free-form surface is given by the Z-axis of that defining formula.

$$Z = \frac{( {r}^{2} / R )}{[ 1 + \sqrt{ } \{ 1 - ( 1 + k ) {( \frac{r}{R} )}^{2} \} ]} + {\sum }_{j = 1}^{66} {C}_{j} {X}^{m} {Y}^{n} \qquad ( a )$$

In formula (a) here, the first term is a spherical term and the second term is a free-form surface term.

In the spherical term,

R is the radius of curvature of the vertex,

k is a conic constant, and

r=√(X²+Y²)

The free-form surface term is

$${\sum }_{j = 1}^{66} CjXmYn = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} …$$

Here Cⱼ (j is an integer of 2 or greater) is a coefficient.

In general, the aforesaid free-form surface has no plane of symmetry at both the X-Z plane and the Y-Z plane. However, by reducing all the odd-numbered terms for X down to zero, that free-form surface can have only one plane of symmetry parallel with the Y-Z plane. For instance, this may be achieved by reducing down to zero the coefficients for the terms C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . .

By reducing all the odd-numbered terms for Y down to zero, the free-form surface can have only one plane of symmetry parallel with the X-Z plane. For instance, this may be achieved by reducing down to zero the coefficients for the terms C₃, C₅, C₈, C₁₀, C₁₂, C₁₄, C₁₇, C₁₉, C₂₁, C₂₃, C₂₅, C₂₇, C₃₀, C₃₂, C₃₄, C₃₆, . . . .

If any one of the directions of the aforesaid plane of symmetry is used as the plane of symmetry and decentration is implemented in a direction corresponding to that, for instance, the direction of decentration of the optical system with respect to the, plane of symmetry parallel with the Y-Z plane is set in the Y-axis direction and the direction of decentration of the optical system with respect to the plane of symmetry parallel with the X-Z plane is set in the X-axis direction, it is then possible to improve productivity while, at the same time, making effective correction of rotationally asymmetric aberrations occurring from decentration.

The aforesaid defining formula (a) is given for the sake of illustration alone: the feature of the invention is that by use of the plane symmetric free-form surface having only one plane of symmetry, it is possible to correct rotationally asymmetric aberrations occurring from decentration while, at the same time, improving productivity.

It is here noted that the term with respect to the free-form surfaces about which no data are given is zero. For the index of refraction, d-line (of 587.56 nm wavelength) refractive indices are given. Length is given in mm.

FIG. 2 is illustrative in the Y-Z section including an axial chief ray 21 of a projecting optical system 6 according to Example 1, and FIG. 3 is an enlarged view of a decentered prism 10 forming part of the projecting optical system 6 of FIG. 2. This optical system is built up of the decentered prism 10 located on a display plane side with respect to an entrance pupil 20 and a display plane 22. Before the entrance pupil 20, there are a laser light source unit 1, a converting optical system 4, a collimator lens system and a light beam shape adjustment optical system, all not shown. Incident laser light is converted by the collimator lens system into substantially parallel light, and the laser light is configured by the beam shape adjustment optical system (beam shaping means) into the desired beam shape. And a biaxial galvano-mirror 5 is positioned at the position of the entrance pupil 20 that is defined by the contour shape of the mirror. The decentered prism 10 is constructed of a medium that has a refractive index greater than 1.3 and comprises an entrance, first surface 11 having transmission, a second surface 12 having reflection plus transmission and a third surface 13 having reflection. Light rays coming from an object (light source) through the entrance pupil 20 enter the medium through the first surface 11, and undergo total reflection at the second surface 12 and then reflection at the third surface 13, transmitting through the second surface 12 this time and out of the decentered prism 10 to form an image on the display plane 22.

And the first 11, the second 12, and the third surface 13 of the decentered prism 10 is constructed of a free-form surface whose Y-Z plane defines only one plane of symmetry, and which has a rotationally asymmetric surface shape capable of giving power to light beams and correcting aberrations occurring from decentration. Using such surface shape for the reflecting surface is particularly effective for correction of aberrations occurring from decentration.

Thus, if the decentered prism 10 wherein at least one of the three surfaces is constructed of a rotationally asymmetric shape surface is used for the projecting optical system 6 of the scanning image projector, it is then possible to set up a projecting optical system that has a low parts count and simplified arrangement and, nonetheless, provides less distorted images with high peripheral resolution even at wider angles of view.

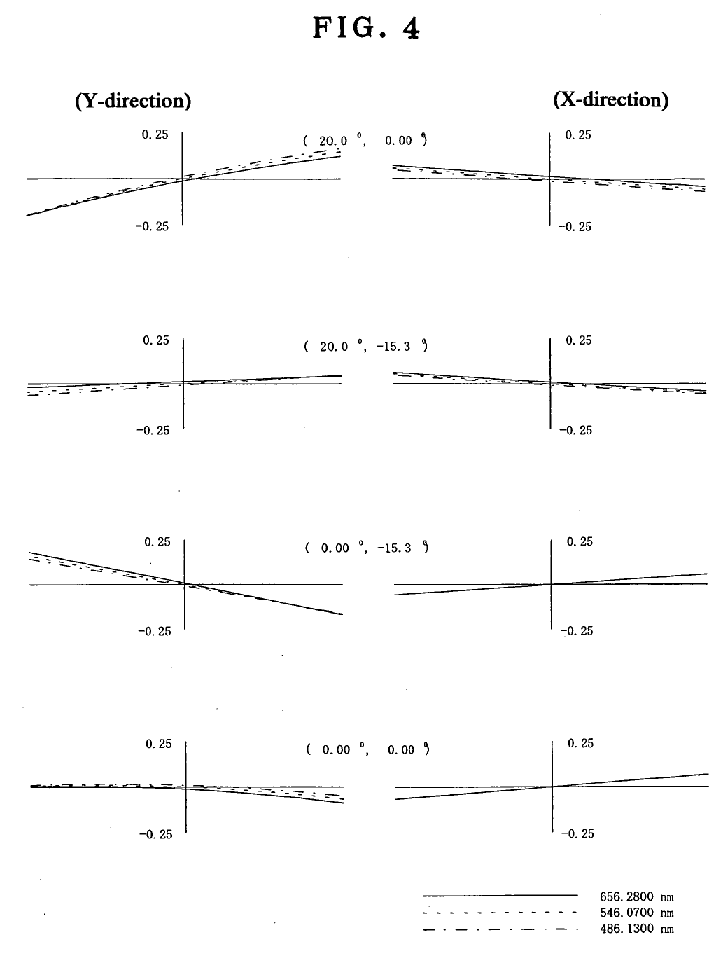

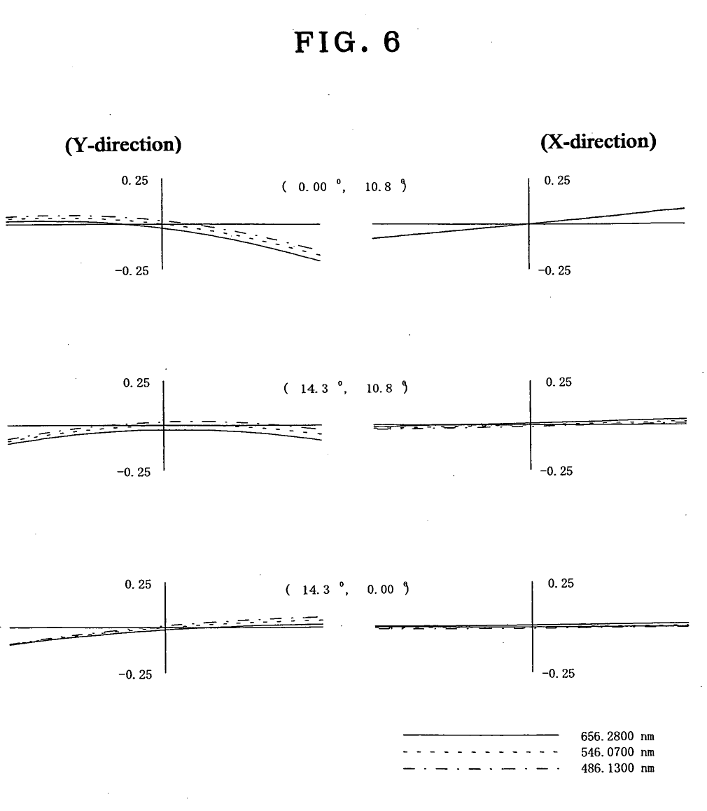

Transverse aberration diagrams for the projecting optical system of Example 1 are shown in FIGS. 4, 5 and 6, wherein the bracketed figures stand for (the angles of view in the X- and Y-directions) and indicate transverse aberrations at those angles of view. The same will go for the following descriptions.

It is here noted that the specifications of the optical system of Example 1 are:

Angle of view: 40°×30.52° (horizontal and vertical)

Entrance pupil diameter: φ2.0 mm

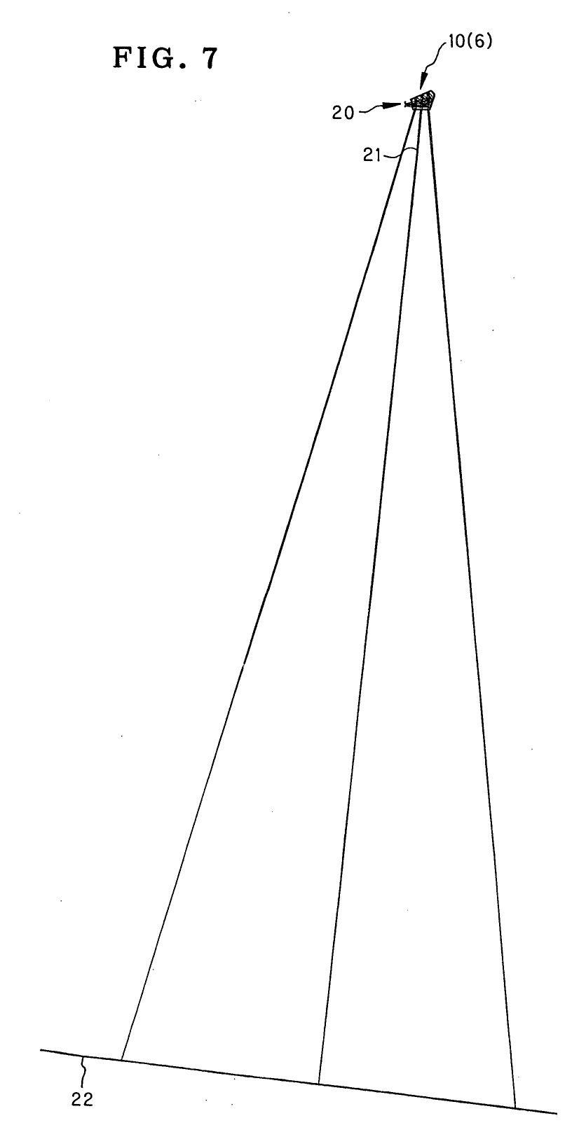

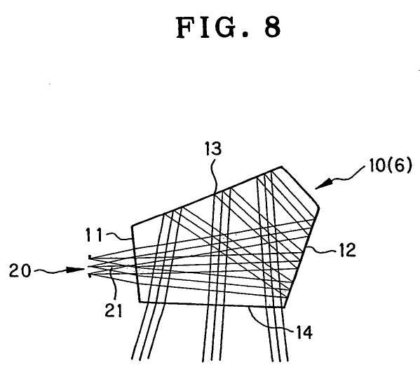

FIG. 7 is illustrative in the Y-Z section including an axial chief ray 21 of a projecting optical system 6 according to Example 2, and FIG. 8 is an enlarged view of a decentered prism 10 forming part of the projecting optical system 6 of FIG. 7. This optical system is built up of the decentered prism 10 located on a display plane side with respect to an entrance pupil 20 and a display plane 22. Before the entrance pupil 20, there are a laser light source unit 1, a converting optical system 4, a collimator lens system and a light beam shape adjustment optical system, all not shown. Incident laser light is converted by the collimator lens system into substantially parallel light, and the laser light is configured by the beam shape adjustment optical system (beam shaping means) into the desired beam shape. And a biaxial galvanomirror 5 is positioned at the position of the entrance pupil 20 that is defined by the contour shape of the mirror. The decentered prism 10 is constructed of a medium that has a refractive index greater than 1.3 and comprises an entrance, first surface 11 having transmission, a second surface 12 having reflection, a third surface 13 having reflection and a fourth surface 14 having transmission. Light rays coming from an object (light source) through the entrance pupil 20 enter the medium through the first surface 11, and undergo reflection at the second surface 12 and then at the third surface 13, transmitting through the fourth surface 14 this time and out of the decentered prism 10 to form an image on the display plane 22. And the second 12 and the third surface 13 are located at such positions that the axial chief ray 21 is reflected at an acute angle, and an optical path from the first 11 to the second surface 12 crosses an optical path from the third 13 to the fourth surface 14 in the prism.

And the first 11, the second 12, the third 13, and the fourth surface 14 of the decentered prism 10 is constructed of a free-form surface whose Y-Z plane defines only one plane of symmetry, and which has a rotationally asymmetric surface shape capable of giving power to light beams and correcting aberrations occurring from decentration. Using such surface shape for the reflecting surface is particularly effective for correction of aberrations occurring from decentration.

Thus, if the decentered prism 10 wherein at least one of the four surfaces is constructed of a rotationally asymmetric shape surface is used for the projecting optical system 6 of the scanning image projector, it is then possible to set up a projecting optical system that has a low parts count and simplified arrangement and, nonetheless, provides less distorted images with high peripheral resolution even at wider angles of view.

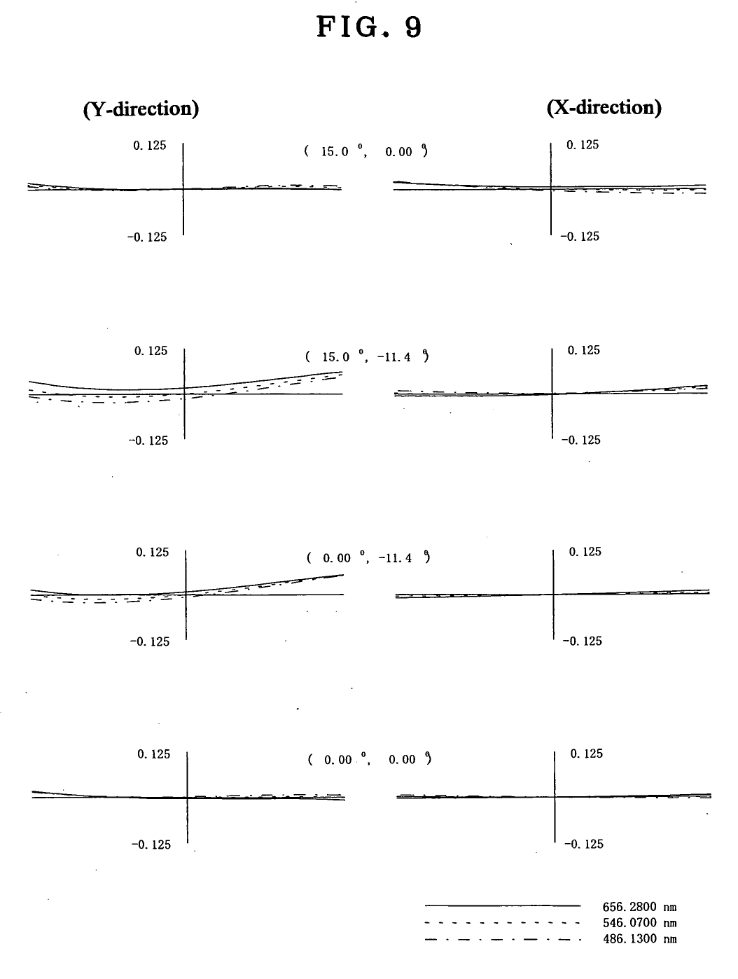

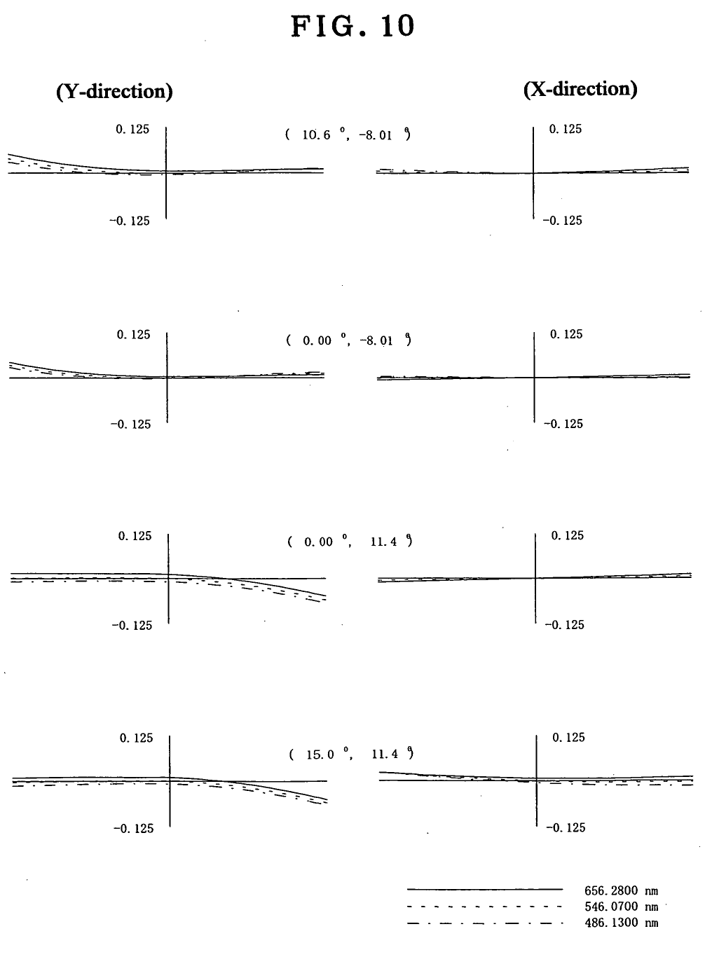

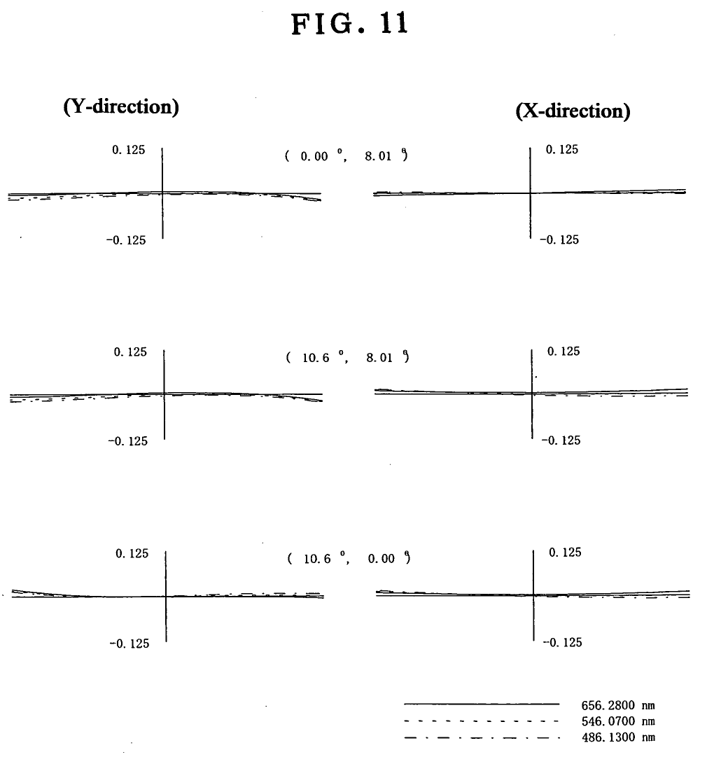

Transverse aberration diagrams for the projecting optical system of Example 2 are shown in FIGS. 9, 10 and 11.

It is here noted that the specifications of the optical system of Example 2 are:

Angle of view: 30°×22.72° (horizontal and vertical)

Entrance pupil diameter: φ1.0 mm

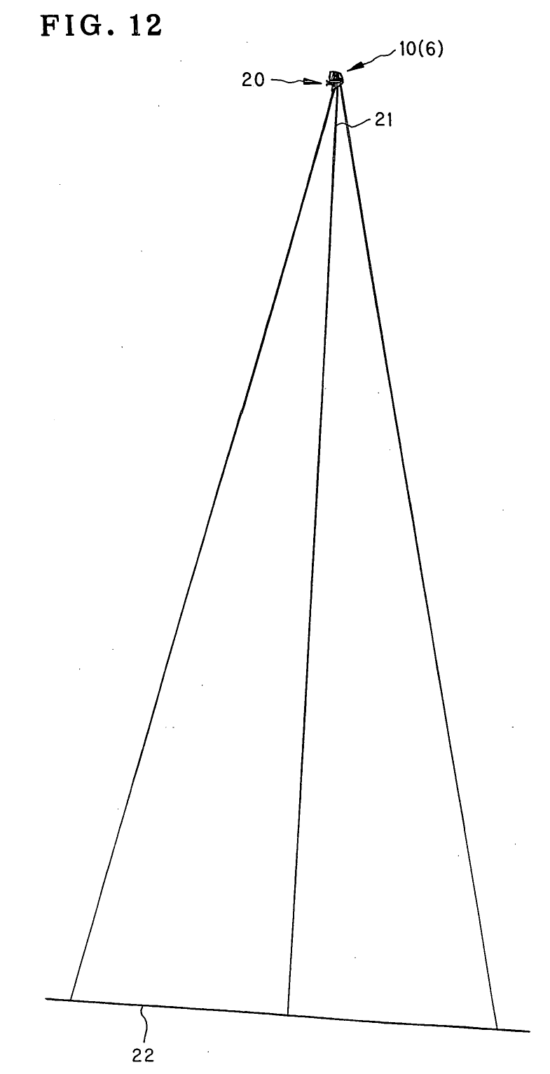

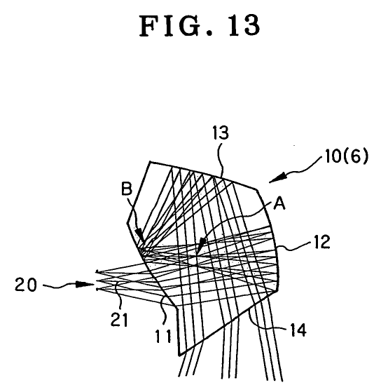

FIG. 12 is illustrative in the Y-Z section including an axial chief ray 21 of a projecting optical system 6 according to Example 3, and FIG. 13 is an enlarged view of a decentered prism 10 forming part of the projecting optical system 6 of FIG. 12. This optical system is built up of the decentered prism 10 located on a display plane side with respect to an entrance pupil 20 and a display plane 22. Before the entrance pupil 20, there are a laser light source unit 1, a converting optical system 4, a collimator lens system and a light beam shape adjustment optical system, all not shown. Incident laser light is converted by the collimator lens system into substantially parallel light, and the laser light is configured by the beam shape adjustment optical system (beam shaping means) into the desired beam shape. And a biaxial galvanomirror 5 is positioned at the position of the entrance pupil 20 that is defined by the contour shape of the mirror. The decentered prism 10 is constructed of a medium that has a refractive index greater than 1.3 and comprises an entrance, first surface 11 having transmission plus reflection, a second surface 12 having reflection, a third surface 13 having reflection and a fourth surface 14 having transmission. Light rays coming from an object (light source) through the entrance pupil 20 enter the medium through the first surface 11, and undergo reflection at the second surface 12, then at an area of the first surface 11 coated with a mirror coating and then at the third surface 13, transmitting through the fourth surface 14 this time and out of the decentered prism 10 to form an image on the display plane 22. And the first 11, the second 12 and the third surface 13 are located at such positions that the axial chief ray 21 is reflected at an acute angle, and an optical path from the third 13 to the fourth surface 14 crosses both an optical path from the first 11 to the second surface 12 and an optical path from the second 12 to the first surface 11.

In the optical path between the second reflecting surface 12 and the first reflecting surface 11, light from the light source is imaged into an intermediate image A, and a pupil B conjugate to the entrance pupil 20 is formed in the decentered prism 10 and on a projection side with respect to the intermediate image A. And that intermediate image A is formed on the display plane 22 via the reflecting surfaces that are the first 11 and the third surface 13 having positive power and the fourth surface 14 that is the exit surface.

And the first 11, the second 12, the third 13, and the fourth surface 14 of the decentered prism 10 is constructed of a free-form surface whose Y-Z plane defines only one plane of symmetry, and which has a rotationally asymmetric surface shape capable of giving power to light beams and correcting aberrations occurring from decentration. Using such surface shape for the reflecting surface is particularly effective for correction of aberrations occurring from decentration.

Thus, if the decentered prism 10 wherein at least one of the four surfaces is constructed of a rotationally asymmetric shape surface is used for the projecting optical system 6 of the scanning image projector, it is then possible to set up a projecting optical system that has a low parts count and simplified arrangement and, nonetheless, provides less distorted images with high peripheral resolution even at wider angles of view.

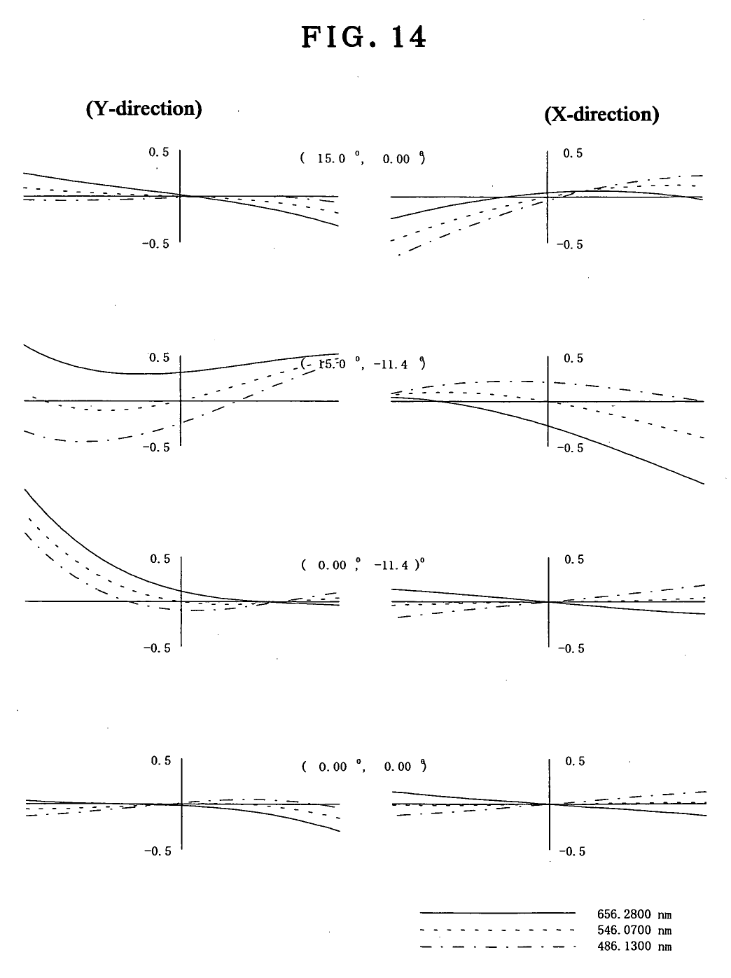

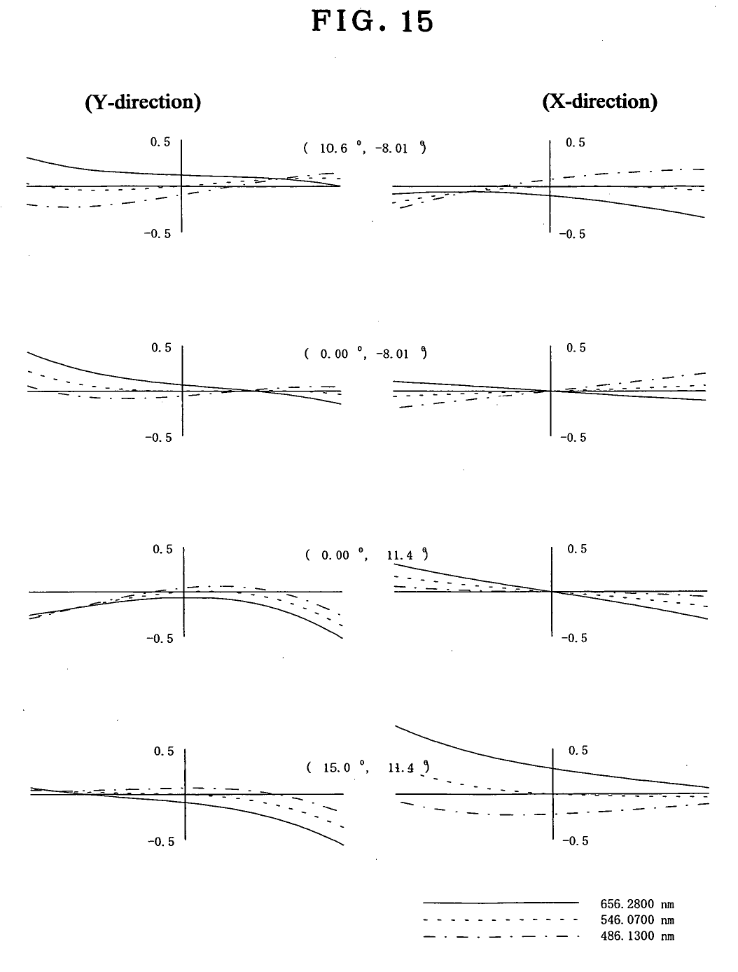

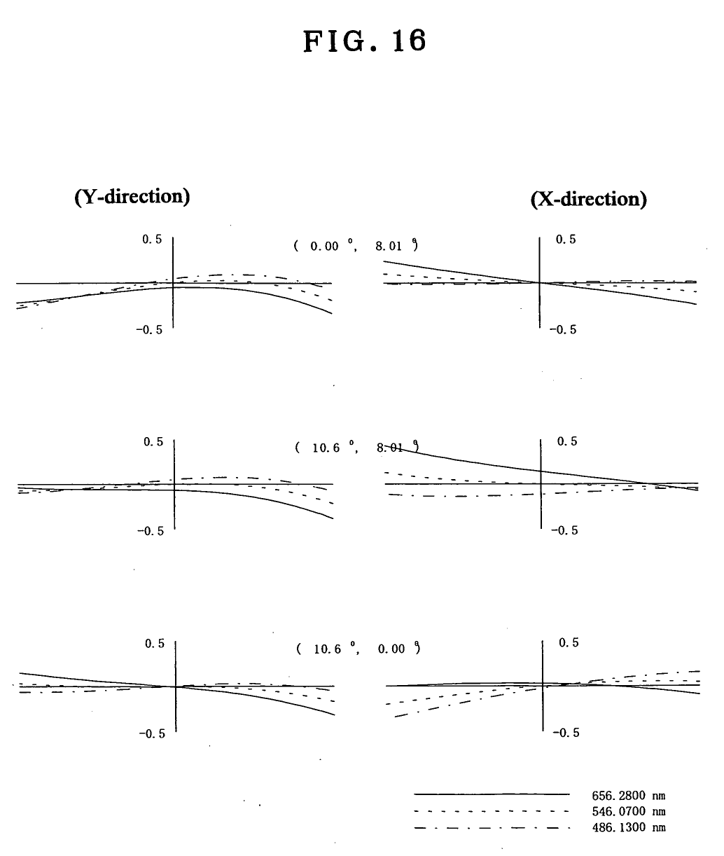

Transverse aberration diagrams for the projecting optical system of Example 3 are shown in FIGS. 14, 15 and 16.

It is here noted that the specifications of the optical system of Example 3 are:

Angle of view: 30°×22.72° (horizontal and vertical)

Entrance pupil diameter: φ1.0 mm

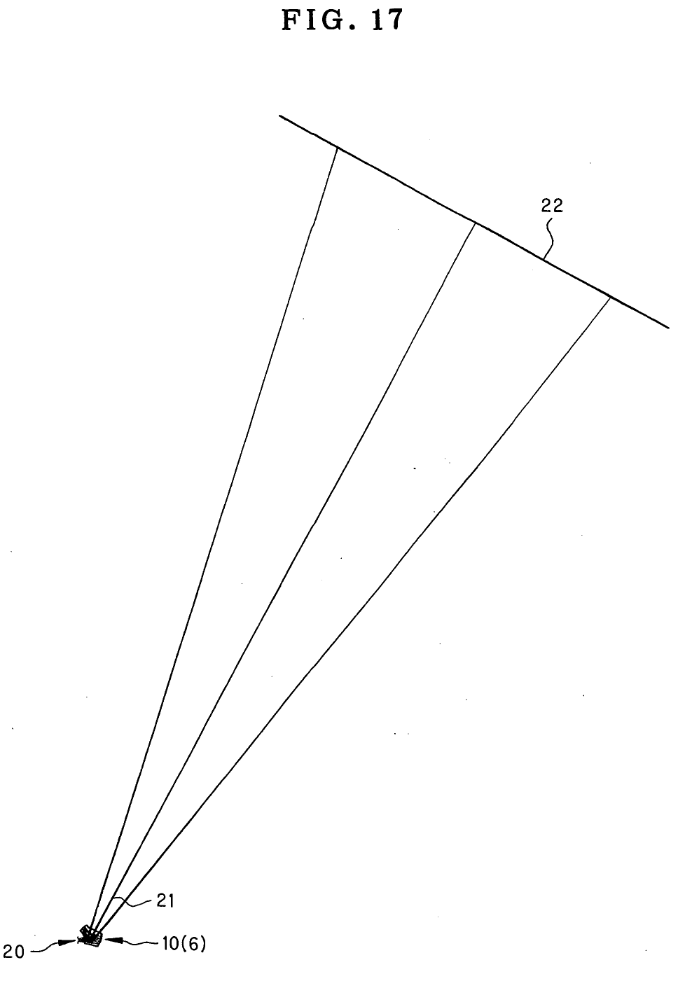

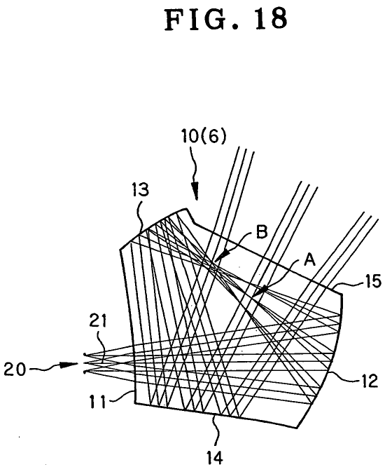

FIG. 17 is illustrative in the Y-Z section including an axial chief ray 21 of a projecting optical system 6 according to Example 4, and FIG. 18 is an enlarged view of a decentered prism 10 forming part of the projecting optical system 6 of FIG. 17. This optical system is built up of the decentered prism 10 located on a display plane side with respect to an entrance pupil 20 and a display plane 22. Before the entrance pupil 20, there are a laser light source unit 1, a converting optical system 4, a collimator lens system and a light beam shape adjustment optical system, all not shown. Incident laser light is converted by the collimator lens system into substantially parallel light, and the laser light is configured by the beam shape adjustment optical system (beam shaping means) into the desired beam shape. And a biaxial galvanomirror 5 is positioned at the position of the entrance pupil 20 that is defined by the contour shape of the mirror. The decentered prism 10 is constructed of a medium that has a refractive index greater than 1.3 and comprises an entrance, first surface 11 having transmission, a second surface 12 having reflection, a third surface 13 having reflection, a fourth surface 14 having reflection and a fifth surface 15 having transmission. Light rays coming from an object (light source) through the entrance pupil 20 enter the medium through the first surface 11, and undergo reflection at the second surface 12, then at the third surface 13 and then at the fourth surface 14, transmitting through the fifth surface 15 having and out of the decentered prism 10 to form an image on the display plane 22. And the second 12, the third 13 and the fourth surface 14 are located at such positions that the axial chief ray 21 is reflected at an acute angle, and an optical path from the fourth 14 to the fifth surface 15 crosses both an optical path from the first 11 to the second surface 12 and an optical path from the second 12 to the third surface 13.

In the optical path between the second reflecting surface 12 and the third reflecting surface 13, light from the light source is imaged into an intermediate image A, and a pupil B conjugate to the entrance pupil 20 is formed in the decentered prism 10 and on a projection side with respect to the intermediate image A. And that intermediate image A is formed on the display plane 22 via the reflecting surfaces that are the third 13 and the fourth surface 14 having positive power and the fifth surface 15 that is the exit surface.

And the first 11, the second 12, the third 13, and the fourth surface 14 (the fifth surface is in planar form) of the decentered prism 10 is constructed of a free-form surface whose Y-Z plane defines only one plane of symmetry, and which has a rotationally asymmetric surface shape capable of giving power to light beams and correcting aberrations occurring from decentration. Using such surface shape for the reflecting surface is particularly effective for correction of aberrations occurring from decentration.

Thus, if the decentered prism 10 wherein at least one of the five surfaces is constructed of a rotationally asymmetric shape surface is used for the projecting optical system 6 of the scanning image projector, it is then possible to set up a projecting optical system that has a low parts count and simplified arrangement and, nonetheless, provides less distorted images with high peripheral resolution even at wider angles of view.

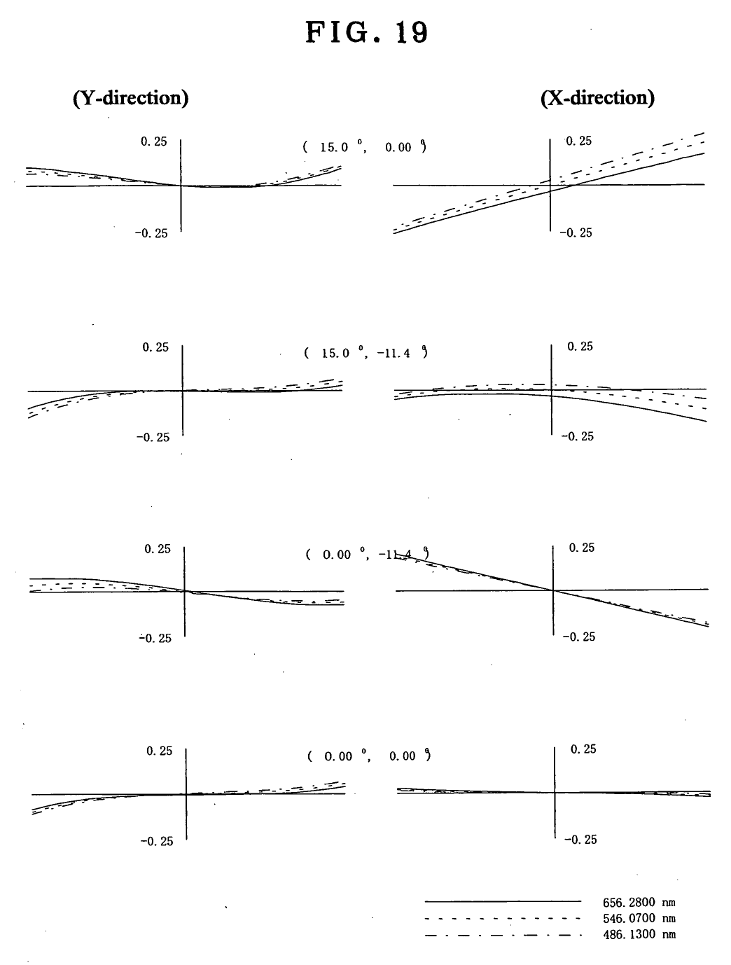

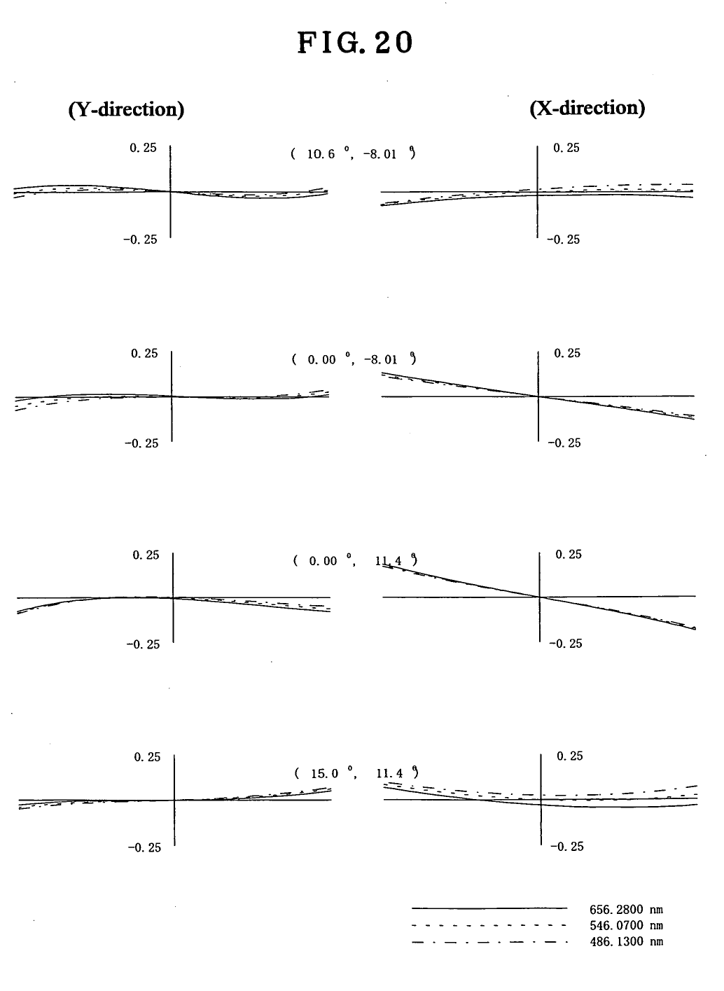

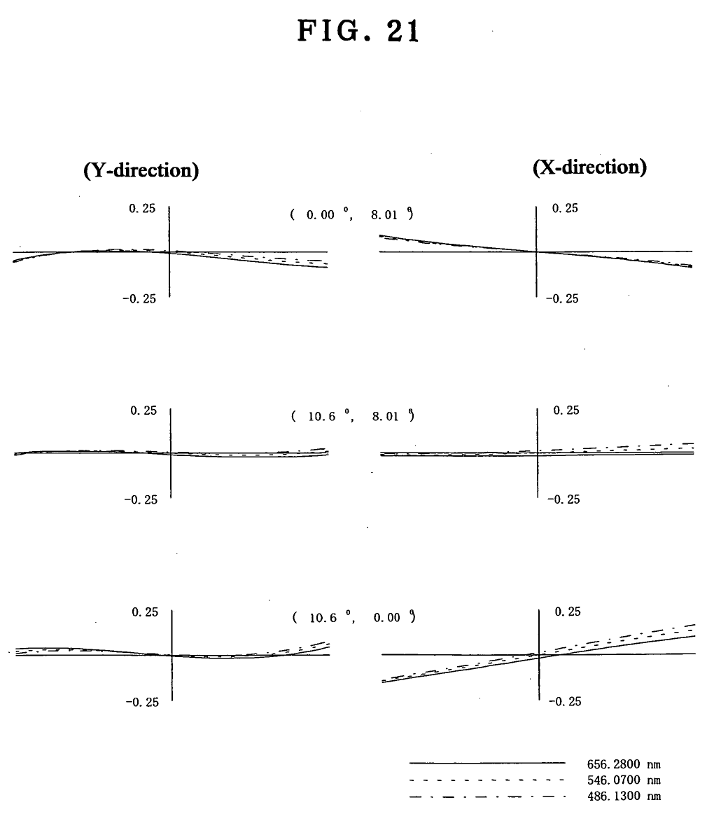

Transverse aberration diagrams for the projecting optical system of Example 4 are shown in FIGS. 19, 20 and 21.

It is here noted that the specifications of the optical system of Example 4 are:

Angle of view: 30°×22.72° (horizontal and vertical)

Entrance pupil diameter: φ1.0 mm

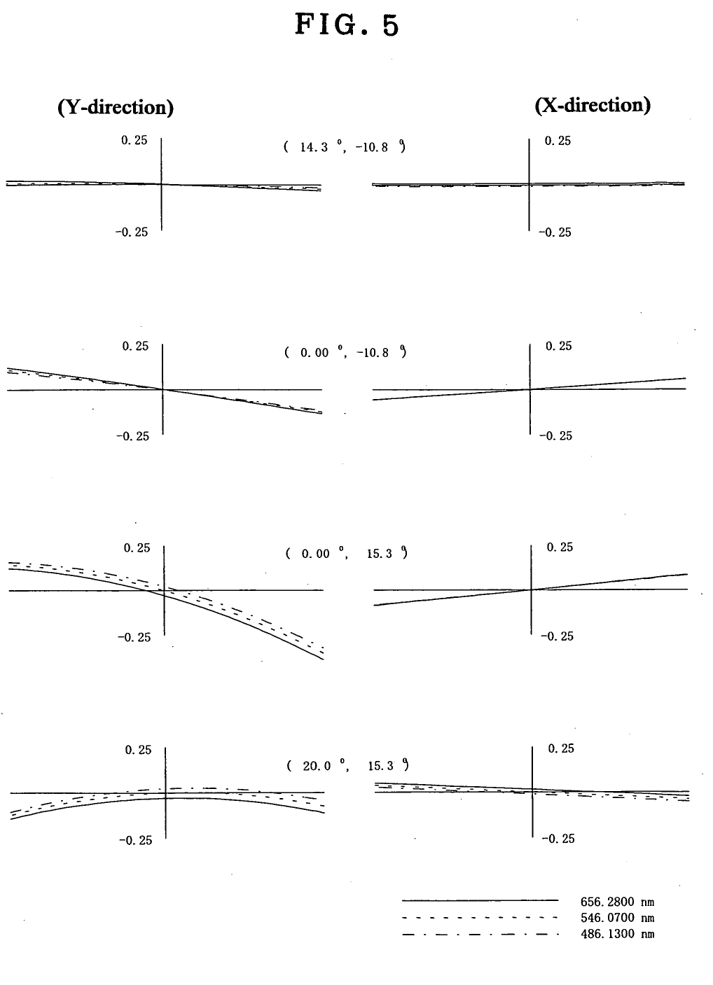

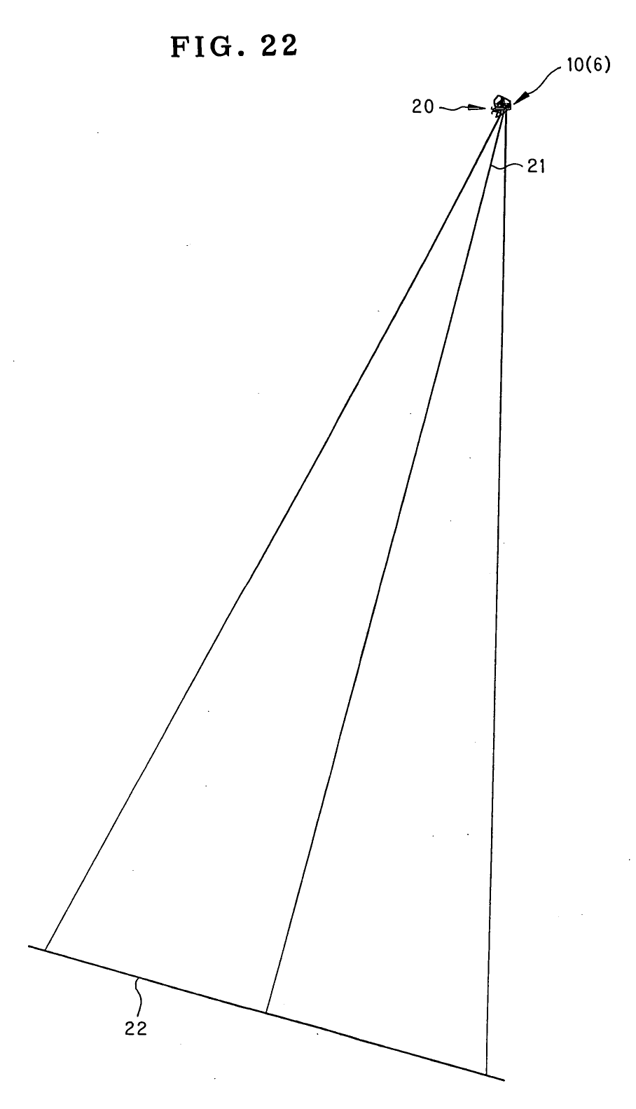

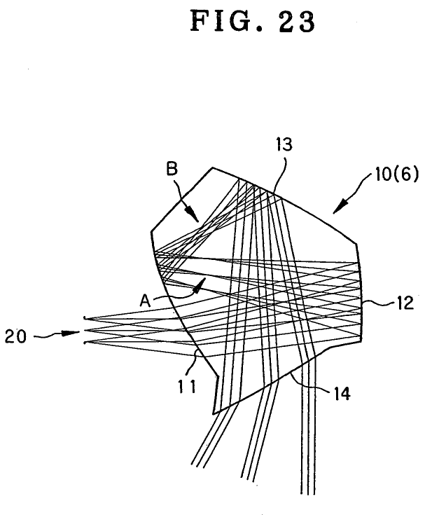

FIG. 22 is illustrative in the Y-Z section including an axial chief ray 21 of a projecting optical system 6 according to Example 5, and FIG. 23 is an enlarged view of a decentered prism 10 forming part of the projecting optical system 6 of FIG. 5. This optical system is built up of the decentered prism 10 located on a display plane side with respect to an entrance pupil 20 and a display plane 22. Before the entrance pupil 20, there are a laser light source unit 1, a converting optical system 4, a collimator lens system and a light beam shape adjustment optical system, all not shown. Incident laser light is converted by the collimator lens system into substantially parallel light, and the laser light is configured by the beam shape adjustment optical system (beam shaping means) into the desired beam shape. And a biaxial galvanomirror 5 is positioned at the position of the entrance pupil 20 that is defined by the contour shape of the mirror. The decentered prism 10 is constructed of a medium that has a refractive index greater than 1.3 and comprises an entrance, first surface 11 having transmission plus reflection, a second surface 12 having reflection, a third surface 13 having reflection and a fourth surface 14 having transmission. Light rays coming from an object (light source) through the entrance pupil 20 enter the medium through the first surface 11, and undergo reflection at the second surface 12, then at a site of the first surface 11 coated with a mirror coating and then at the third surface 13, transmitting through the fourth surface 14 this time and out of the decentered prism 10 to form an image on the display plane 22. And the second 12, the first surface 11 and the third surface 13 are located at such positions that the axial chief ray 21 is reflected at an acute angle, and an optical path from the third 13 to the fourth surface 14 crosses both an optical path from the first 11 to the second surface 12 and an optical path from the second 12 to the first surface 11.

In the optical path between the second reflecting surface 12 and the first reflecting surface 11, light from the light source is imaged into an intermediate image A, and a pupil B conjugate to the entrance pupil 20 is formed in the decentered prism 10 and on a projection side with respect to the intermediate image A. And that intermediate image A is formed on the display plane 22 via the reflecting surfaces that are the first 11 and the third surface 13 having positive power and the fourth surface 14 that is the exit surface.

And the first 11, the second 12, the third 13, and the fourth surface 14 of the decentered prism 10 is constructed of a free-form surface whose Y-Z plane defines only one plane of symmetry, and which has a rotationally asymmetric surface shape capable of giving power to light beams and correcting aberrations occurring from decentration. Using such surface shape for the reflecting surface is particularly effective for correction of aberrations occurring from decentration.

Thus, if the decentered prism 10 wherein at least one of the four surfaces is constructed of a rotationally asymmetric shape surface is used for the projecting optical system 6 of the scanning image projector, it is then possible to set up a projecting optical system that has a low parts count and simplified arrangement and, nonetheless, provides less distorted images with high peripheral resolution even at wider angles of view.

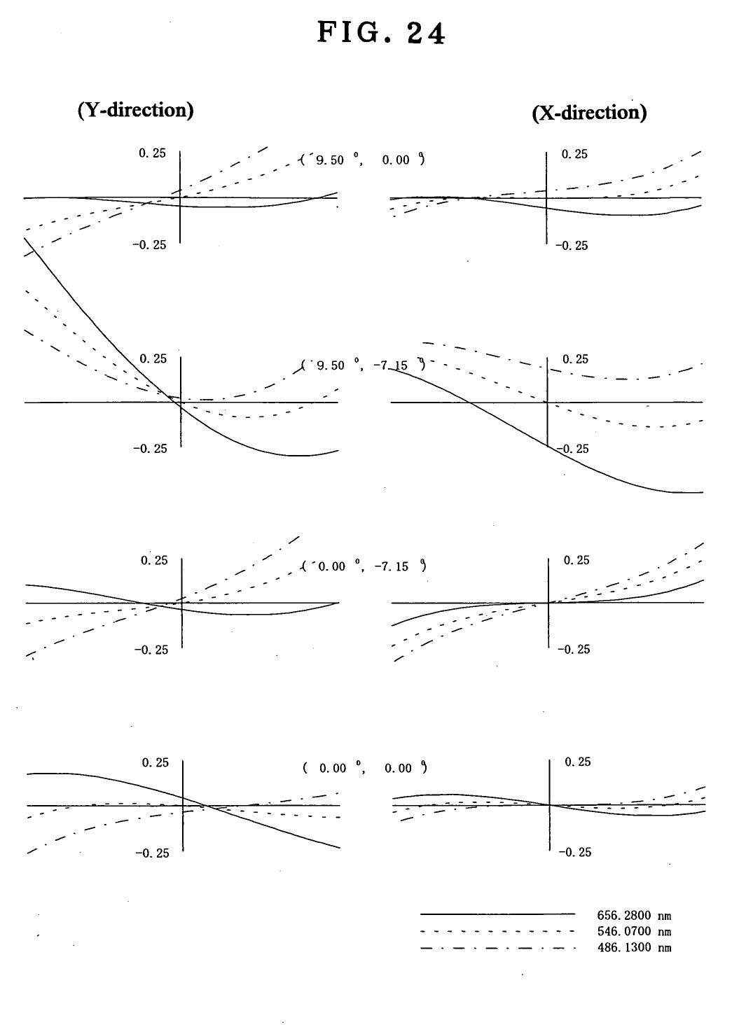

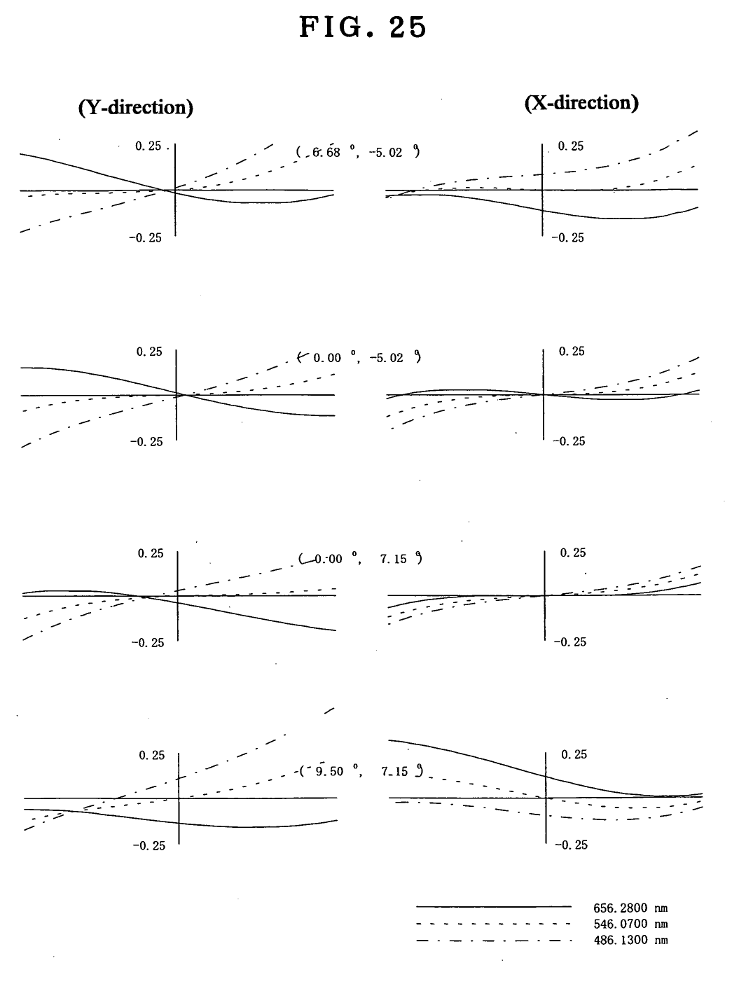

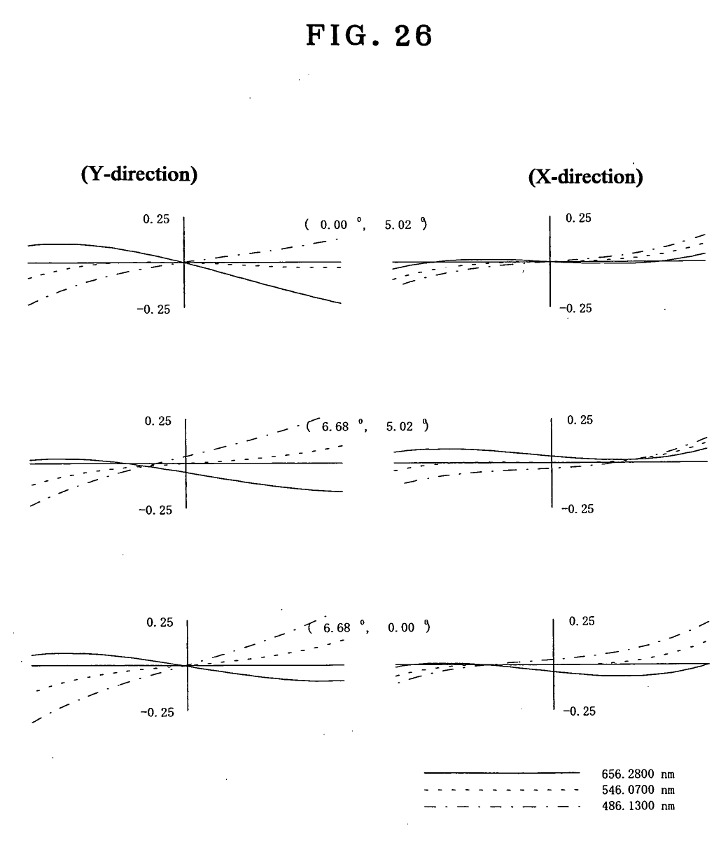

Transverse aberration diagrams for the projecting optical system of Example 5 are shown in FIGS. 24, 25 and 26.

It is here noted that the specifications of the optical system of Example 5 are:

Angle of view: 20°×15.07° (horizontal and vertical)

Entrance pupil diameter: φ1.0 mm

In this example, the scanning angle upon projection is wider than the scanning angle by the deflector. Although the angle of incidence of light on the decentered prism 10 is 20°×15.07° in terms of vertical, and horizontal full angle as described above, the angle of exit of light beams out of the decentered prism 10 is 38.35°×27.20° in terms of vertical, and horizontal full angle.

Set out below are key parameters in Examples 1 to 5. Note here that the abbreviations “FFS”, “RS”, and “HPP” stand for a free-form surface, a reflecting surface, and a virtual plane, respectively, and that “E-00n where n is an integer” means “×10^{-n”.}

### EXAMPLE 1

| Surface | Radius of | Surface | Displacement | Refractive | Abbe's |
|---|---|---|---|---|---|
| No. | curvature | separation | and tilt | index | No. |
| Object | ∞ | ∞ | | | |
| plane | | | | | |
| 1 | ∞ (Stop) | | | | |
| 2 | FFS[1] | | (1) | 1.5254 | 56.2 |
| 3 | FFS[2] (RS) | | (2) | 1.5254 | 56.2 |
| 4 | FFS[3] (RS) | | (3) | 1.5254 | 56.2 |
| 5 | FFS[2] | | (2) | | |
| 6 | ∞ (HPP) | 580.79 | (4) | | |
| Image | ∞ | | | | |
| plane | | | | | |

FFS[1]

| | | | | | |
|---|---|---|---|---|---|
| C₄ | 7.8211e−004 | C₆ | −3.0540e−003 | C₈ | 7.9638e−005 |

FFS[2]

| | | | | | |
|---|---|---|---|---|---|
| C₄ | 2.4895e−004 | C₆ | 5.2606e−004 | C₈ | 5.9100e−006 |
| C₁₀ | −7.4194e−006 | | | | |

FFS[3]

| | | | | | |
|---|---|---|---|---|---|
| C₄ | 5.9881e−004 | C₆ | 2.4684e−003 | C₈ | −1.1941e−006 |
| C₁₀ | −8.5629e−006 | | | | |

Displacement and tilt(1)

| | | | | | |
|---|---|---|---|---|---|
| X | 0.00 | Y | 13.28 | Z | 7.14 |
| α | 12.60 | β | 0.00 | γ | 0.00 |

Displacement and tilt(2)

| | | | | | |
|---|---|---|---|---|---|
| X | 0.00 | Y | 1.10 | Z | 10.30 |
| α | −49.22 | β | 0.00 | γ | 0.00 |

Displacement and tilt(3)

| | | | | | |
|---|---|---|---|---|---|
| X | 0.00 | Y | 0.12 | Z | −21.19 |
| α | −69.80 | β | 0.00 | γ | 0.00 |

Displacement and tilt(4)

| | | | | | |
|---|---|---|---|---|---|
| X | 0.00 | Y | 0.00 | Z | 0.00 |
| α | −6.85 | β | 0.00 | γ | 0.00 |

### EXAMPLE 2

| Surface | Radius of | Surface | Displacement | Refractive | Abbe's |
|---|---|---|---|---|---|
| No. | curvature | separation | and tilt | index | No. |
| Object | ∞ | ∞ | | | |
| plane | | | | | |
| 1 | ∞ (Stop) | | | | |
| 2 | FFS[1] | | (1) | 1.5254 | 56.2 |
| 3 | FFS[2] (RS) | | (2) | 1.5254 | 56.2 |
| 4 | FFS[3] (RS) | | (3) | 1.5254 | 56.2 |
| 5 | FFS[4] | | (4) | | |
| Image | ∞ | | (5) | | |
| plane | | | | | |

FFS[1]

| | | | | | |
|---|---|---|---|---|---|
| C₄ | 3.2336e−003 | C₆ | 3.4762e−004 | C₈ | 1.7106e−004 |
| C₁₀ | −1.0704e−003 | C₁₁ | 1.8307e−006 | C₁₃ | −6.7084e−005 |
| C₁₅ | 1.2066e−004 | | | | |

FFS[2]

| | | | | | |
|---|---|---|---|---|---|
| C₄ | 1.0143e−004 | C₆ | −5.5935e−004 | C₈ | −4.3497e−005 |
| C₁₀ | −7.2330e−005 | | | | |

FFS[3]

| | | | | | |
|---|---|---|---|---|---|
| C₄ | −4.0301e−005 | C₆ | −1.3377e−004 | C₈ | −3.7990e−005 |
| C₁₀ | −8.8667e−005 | C₁₁ | −1.2060e−006 | C₁₃ | 2.0679e−006 |
| C₁₅ | −3.2127e−006 | | | | |

FFS[4]

| | | | | | |
|---|---|---|---|---|---|
| C₄ | 1.3919e−003 | C₆ | 7.9802e−004 | C₈ | −8.2113e−005 |
| C₁₀ | −1.6745e−004 | C₁₁ | −1.9684e−006 | C₁₃ | 1.1748e−005 |

Displacement and tilt(1)

| | | | | | |
|---|---|---|---|---|---|
| X | 0.00 | Y | −2.00 | Z | 3.13 |
| α | 3.25 | β | 0.00 | γ | 0.00 |

Displacement and tilt(2)

| | | | | | |
|---|---|---|---|---|---|
| X | 0.00 | Y | −1.05 | Z | 13.01 |
| α | −20.86 | β | 0.00 | γ | 0.00 |

Displacement and tilt(3)

| | | | | | |
|---|---|---|---|---|---|
| X | 0.00 | Y | 5.00 | Z | 8.87 |
| α | −68.91 | β | 0.00 | γ | 0.00 |

Displacement and tilt(4)

| | | | | | |
|---|---|---|---|---|---|
| X | 0.00 | Y | −2.46 | Z | 6.85 |
| α | −92.64 | β | 0.00 | γ | 0.00 |

Displacement and tilt(5)

| | | | | | |
|---|---|---|---|---|---|
| X | 0.00 | Y | −523.02 | Z | −49.46 |
| α | −96.28 | β | 0.00 | γ | 0.00 |

### EXAMPLE 3

| Surface | Radius of | Surface | Displacement | Refractive | Abbe's |
|---|---|---|---|---|---|
| No. | curvature | separation | and tilt | index | No. |
| Object | ∞ | ∞ | | | |
| plane | | | | | |
| 1 | ∞ (Stop) | | | | |
| 2 | FFS[1] | | (1) | 1.5254 | 56.2 |
| 3 | FFS[2] (RS) | | (2) | 1.5254 | 56.2 |
| 4 | FFS[1] (RS) | | (1) | 1.5254 | 56.2 |
| 5 | FFS[3] (RS) | | (3) | 1.5254 | 56.2 |
| 6 | FFS[4] | | (4) | | |
| Image | ∞ | | (5) | | |
| plane | | | | | |

FFS[1]

| | | | | | |
|---|---|---|---|---|---|
| C₄ | −1.8864e−003 | C₆ | 2.6799e−002 | C₈ | −5.1216e−003 |
| C₁₀ | 3.3812e−003 | C₁₁ | 2.4721e−004 | C₁₃ | 2.6888e−004 |
| C₁₅ | −2.7287e−004 | | | | |

FFS[2]

| | | | | | |
|---|---|---|---|---|---|
| C₄ | −2.4378e−002 | C₆ | −4.1927e−002 | C₈ | −6.1601e−004 |
| C₁₀ | 2.2410e−004 | | | | |

FFS[3]

| | | | | | |
|---|---|---|---|---|---|
| C₄ | −3.2053e−002 | C₆ | −1.1008e−002 | C₈ | −1.5706e−003 |
| C₁₀ | 1.1238e−003 | C₁₁ | 6.1963e−005 | C₁₃ | 1.1598e−005 |
| C₁₅ | 9.4628e−005 | | | | |

FFS[4]

| | | | | | |
|---|---|---|---|---|---|
| C₄ | 7.1494e−002 | C₆ | −6.1509e−003 | C₈ | −4.0304e−003 |
| C₁₀ | 1.0843e−003 | C₁₁ | −5.8804e−004 | C₁₃ | −1.4946e−004 |

Displacement and tilt(1)

| | | | | | |
|---|---|---|---|---|---|
| X | 0.00 | Y | −0.15 | Z | 3.95 |
| α | 35.34 | β | 0.00 | γ | 0.00 |

Displacement and tilt(2)

| | | | | | |
|---|---|---|---|---|---|
| X | 0.00 | Y | 1.82 | Z | 11.51 |
| α | 7.10 | β | 0.00 | γ | 0.00 |

Displacement and tilt(3)

| | | | | | |
|---|---|---|---|---|---|
| X | 0.00 | Y | 7.19 | Z | 5.60 |
| α | 78.93 | β | 0.00 | γ | 0.00 |

Displacement and tilt(4)

| | | | | | |
|---|---|---|---|---|---|
| X | 0.00 | Y | −1.97 | Z | 9.13 |
| α | 124.49 | β | 0.00 | γ | 0.00 |

Displacement and tilt(5)

| | | | | | |
|---|---|---|---|---|---|
| X | 0.00 | Y | −651.28 | Z | −28.48 |
| α | 86.73 | β | 0.00 | γ | 0.00 |

### EXAMPLE 4

| Surface | Radius of | Surface | Displacement | Refractive | Abbe's |
|---|---|---|---|---|---|
| No. | curvature | separation | and tilt | index | No. |
| Object | ∞ | ∞ | | | |
| plane | | | | | |
| 1 | ∞ (Stop) | | | | |
| 2 | FFS[1] | | (1) | 1.5254 | 56.2 |
| 3 | FFS[2] (RS) | | (2) | 1.5254 | 56.2 |
| 4 | FFS[3] (RS) | | (3) | 1.5254 | 56.2 |
| 5 | FFS[4] (RS) | | (4) | 1.5254 | 56.2 |
| 6 | ∞ | | (5) | | |
| Image | ∞ | | (6) | | |
| plane | | | | | |

FFS[1]

| | | | | | |
|---|---|---|---|---|---|
| C₄ | 4.4321e−003 | C₆ | −1.4428e−002 | C₈ | −3.0159e−003 |
| C₁₀ | 2.8753e−003 | C₁₁ | 1.0928e−003 | C₁₃ | 8.6408e−004 |
| C₁₅ | −4.2448e−004 | | | | |

FFS[2]

| | | | | | |
|---|---|---|---|---|---|
| C₄ | −2.1923e−002 | C₆ | −3.8514e−002 | C₈ | −4.4917e−004 |
| C₁₀ | −6.1158e−005 | C₁₁ | −7.9019e−006 | C₁₃ | −7.1068e−005 |
| C₁₅ | 1.6403e−005 | | | | |

FFS[3]

| | | | | | |
|---|---|---|---|---|---|
| C₄ | 2.1281e−002 | C₆ | 3.4223e−002 | C₈ | 4.9564e−004 |
| C₁₀ | 2.0107e−004 | C₁₁ | 1.0048e−004 | C₁₃ | 1.9023e−004 |
| C₁₅ | −3.5865e−006 | | | | |

FFS[4]

| | | | | | |
|---|---|---|---|---|---|
| C₄ | −1.8124e−002 | C₆ | 3.8989e−003 | C₈ | −7.3645e−007 |
| C₁₀ | 7.3406e−005 | C₁₁ | 2.1544e−004 | C₁₃ | 7.7401e−005 |
| C₁₅ | −5.4784e−005 | | | | |

Displacement and tilt(1)

| | | | | | |
|---|---|---|---|---|---|
| X | 0.00 | Y | −0.72 | Z | 3.35 |
| α | 1.19 | β | 0.00 | γ | 0.00 |

Displacement and tilt(2)

| | | | | | |
|---|---|---|---|---|---|
| X | 0.00 | Y | 1.01 | Z | 16.15 |
| α | −15.06 | β | 0.00 | γ | 0.00 |

Displacement and tilt(3)

| | | | | | |
|---|---|---|---|---|---|
| X | 0.00 | Y | 9.40 | Z | 5.53 |
| α | −62.34 | β | 0.00 | γ | 0.00 |

Displacement and tilt(4)

| | | | | | |
|---|---|---|---|---|---|
| X | 0.00 | Y | −2.98 | Z | 6.02 |
| α | −98.08 | β | 0.00 | γ | 0.00 |

Displacement and tilt(5)

| | | | | | |
|---|---|---|---|---|---|
| X | 0.00 | Y | 6.88 | Z | 11.70 |
| α | 63.99 | β | 0.00 | γ | 0.00 |

Displacement and tilt(6)

| | | | | | |
|---|---|---|---|---|---|
| X | 0.00 | Y | 492.64 | Z | 269.61 |
| α | 62.08 | β | 0.00 | γ | 0.00 |

### EXAMPLE 5

| Surface | Radius of | Surface | Displacement | Refractive | Abbe's |
|---|---|---|---|---|---|
| No. | curvature | separation | and tilt | index | No. |
| Object | ∞ | ∞ | | | |
| plane | | | | | |
| 1 | ∞ (Stop) | | | | |
| 2 | FFS[1] | | (1) | 1.5254 | 56.2 |
| 3 | FFS[2] (RS) | | (2) | 1.5254 | 56.2 |
| 4 | FFS[1] (RS) | | (1) | 1.5254 | 56.2 |
| 5 | FFS[3] (RS) | | (3) | 1.5254 | 56.2 |
| 6 | FFS[4] | | (4) | | |
| Image | ∞ | | (5) | | |
| plane | | | | | |

FFS[1]

| | | | | | |
|---|---|---|---|---|---|
| C₄ | −1.4999e−002 | C₆ | 3.7510e−002 | C₈ | −7.3349e−003 |
| C₁₀ | 3.1467e−003 | C₁₁ | 3.0604e−004 | C₁₃ | −2.9467e−004 |
| C₁₅ | 5.5794e−005 | | | | |

FFS[2]

| | | | | | |
|---|---|---|---|---|---|
| C₄ | −2.5781e−002 | C₆ | −2.7720e−002 | C₈ | −1.1244e−003 |
| C₁₀ | 2.8792e−004 | | | | |

FFS[3]

| | | | | | |
|---|---|---|---|---|---|
| C₄ | −5.2913e−002 | C₆ | −2.7602e−002 | C₈ | −1.5934e−004 |
| C₁₀ | −7.4192e−004 | C₁₁ | −1.1320e−004 | C₁₃ | 1.2255e−004 |
| C₁₅ | 2.1700e−006 | | | | |

FFS[4]

| | | | | | |
|---|---|---|---|---|---|
| C₄ | 6.8149e−002 | C₆ | 9.4781e−003 | C₈ | −2.6667e−003 |
| C₁₀ | 2.0910e−004 | C₁₁ | −4.3883e−004 | C₁₃ | −1.7984e−004 |

Displacement and tilt(1)

| | | | | | |
|---|---|---|---|---|---|
| X | 0.00 | Y | 0.89 | Z | 4.02 |
| α | 25.73 | β | 0.00 | γ | 0.00 |

Displacement and tilt(2)

| | | | | | |
|---|---|---|---|---|---|
| X | 0.00 | Y | 2.46 | Z | 12.17 |
| α | 4.34 | β | 0.00 | γ | 0.00 |

Displacement and tilt(3)

| | | | | | |
|---|---|---|---|---|---|
| X | 0.00 | Y | 7.41 | Z | 5.02 |
| α | 73.68 | β | 0.00 | γ | 0.00 |

Displacement and tilt(4)

| | | | | | |
|---|---|---|---|---|---|
| X | 0.00 | Y | −2.87 | Z | 7.35 |
| α | 119.32 | β | 0.00 | γ | 0.00 |

Displacement and tilt(5)

| | | | | | |
|---|---|---|---|---|---|
| X | 0.00 | Y | −620.53 | Z | −157.53 |
| α | 74.99 | β | 0.00 | γ | 0.00 |

What we claim is:

1. A scanning image projector, comprising:
a light source unit that gives out a light beam modulated on the basis of image information,
a deflector that reflects said light beam for deflecting and scanning it in a two-dimensional direction, and
a projecting optical system that projects a light beam reflected by said deflector toward a projection direction to form a two-dimensional image, wherein:
said projecting optical system comprises a plurality of reflecting surfaces tilted with respect to a chief ray of a light beam leading to a center of said projected image,
at least one of said plurality of reflecting surfaces is a curved reflecting surface of concave shape at a position where the chief ray of a light beam leading to the center of said projected image goes by, and
a chief ray of a light beam leading to an end of said image leaves in a direction away form the chief ray of the light beam leading to the center of said projected image as it is out of said projecting optical system.

2. The scanning image projector according to claim 1, wherein said curved reflecting surface in said projecting optical system is configured into an irrotationally symmetric, aspheric shape.

3. The scanning image projector according to claim 1, wherein when said curved reflecting surface is defined as a first curved reflecting surface, said projecting optical system has a second curved reflecting surface in addition to said first curved reflecting surface.

4. The scanning image projector according to claim 3, wherein said first, and said second curved reflecting surface is configured into an irrotationally symmetric, aspheric shape.

5. The scanning image projector according to claim 3, wherein said projecting optical system comprises a prism having internal reflection surfaces defined by said first, and said second curved reflecting surface.

6. The scanning image projector according to claim 5, wherein:
said prism in said projecting optical system includes three optical surfaces:
a first surface having transmission,
a second surface having internal reflection plus transmission, and
a third surface having reflection;
an optical path from said first surface to said third surface is filled with a medium having a refractive index greater than 1.3; and
a light beam from said deflector takes an optical path of reflection: it enters the prism through said first surface, undergoes reflection at said second surface and then at said third surface, transmitting said second surface and out of the prism.

7. The scanning image projector according to claim 5, wherein:
said prism in said projecting optical system includes four optical surfaces:
a first surface having transmission,
a second surface having internal reflection,
a third surface having internal reflection, and
a fourth surface have transmission;
an optical path from said first surface to said fourth surface is filled with a medium having a refractive index greater than 1.3; and
a light beam from said deflector takes an optical path of reflection: it enters the prism through said first surface, undergoes reflection at said second surface, then at said third surface, transmitting through said fourth surface and out of the prism.

8. The scanning image projector according to claim 7, wherein said second surface, and said third surface is located such that the light beam leading to the center of the projected image is reflected at an acute angle, and the light beam leading to the center of said projected image crosses itself in the prism; and
said second surface, and said third surface has a concave shape at a position where the chief ray of the light beam leading to the center of said projected image goes by.

9. The scanning image projector according to claim 8, wherein said fourth surface is concave on an exit side.

10. The scanning image projector according to claim 3, wherein both said first curved reflecting surface and said second curved reflecting surface are concave reflecting surfaces, and an intermediate image is formed in an optical path between said first curved reflecting surface and said second curved reflecting surface.

11. The scanning image projector according to claim 10, wherein said first curved reflecting surface is opposite to said second curved reflecting surface with the intermediate image sandwiched between them.

12. The scanning image projector according to claim 10, wherein a pupil conjugate to an entrance pupil is formed in said projecting optical system and on a projection side with respect to said intermediate image.

13. The scanning image projector according to claim 5, wherein said prism in said projecting optical system includes at least four optical surfaces, and within said prism, there is the intermediate image formed, and enlarged for projection.

14. The scanning image projector according to claim 13, wherein:
said prism in said projecting optical system includes four optical surfaces:
a first surface having transmission plus reflection,
a second surface having internal reflection,
a third surface having internal reflection, and
a fourth surface having transmission;
an optical path from said first surface to said fourth surface is filled with a medium having a refractive index greater than 1.3;
a light beam from said deflector takes an optical path of reflection: it enters the prism through said first surface, undergoes reflection at said second surface, then at said first surface and then at said third surface, transmitting through said fourth surface and out of the prism; and
said intermediate image is formed between said second surface and said third surface.

15. The scanning image projector according to claim 14, wherein there is a pupil formed in said prism.

16. The scanning image projector according to claim 15, wherein said pupil is formed in an optical path between said intermediate image and said third surface.

17. The scanning image projector according to claim 16, wherein said first surface is provided with a light beam reflection coating at a position upon which a light beam reflected at said second surface strikes.

18. The scanning image projector according to claim 14, wherein said intermediate image is formed in an optical path from said second surface to said first surface, and said second surface and said first surface have a concave reflecting surface.

19. The scanning image projector according to claim 14, wherein an optical path from said third surface to said fourth surface crosses both an optical path from said first surface to said second surface and an optical path from said second surface to said first surface.

20. The scanning image projector according to claim 13, wherein:
said prism in said projecting optical system includes five optical surfaces:
a first surface having transmission,
a second surface having internal reflection,
a third surface having internal reflection,
a fourth surface having internal reflection, and
a fifth surface having transmission;
an optical path from said first surface to said fifth surface is filled with a medium having a refractive index greater than 1.3;
a light beam from said deflector takes an optical path of reflection: it enters the medium through said first surface, undergoes reflection at said second surface, then at said third surface and then at said fourth surface, transmitting through said fifth surface and out of the prism; and
said intermediate image is formed between said second surface and said fourth surface.

21. The scanning image projector according to claim 20, wherein there is a pupil formed in said prism.

22. The scanning image projector according to claim 21, wherein said pupil is formed in an optical path between said intermediate image and said fourth surface.

23. The scanning image projector according to claim 20, wherein said intermediate image is formed in an optical path from said second surface to said third surface, and said second surface, and said third surface has a concave reflecting surface.

24. The scanning image projector according to claim 23, wherein said fourth surface has a convex reflecting surface.

25. The scanning image projector according to claim 20, wherein an optical path from said fourth surface to said fifth surface crosses both an optical path from said first surface to said second surface and an optical path from said second surface to said third surface.

26. The scanning image projector according to claim 1, wherein said deflector includes a mirror with mutually orthogonal two axes as axes of rotation.

27. The scanning image projector according to claim 1, which includes between said light source unit and said deflector a converting optical system adapted to convert a light beam from said light source unit into a light beam of given shape and given diameter.

28. The scanning image projector according to claim 27, wherein said light source unit is a laser light source unit.
